(19) United States
(12) Patent Application Publication
(10) Pub. No.: US 2003/0076736 A1
(43) Pub. Date: Apr. 24, 2003

(54) Systems and methods for weighing and charging

(76) Inventors: Dana Buker, Wilmington, DE (US); Stephen R. Brazzell, Buford, GA (US)

Correspondence Address: STEPHEN B. DAVIS, BRISTOL-MYERS SQUIBB COMPANY, PATENT DEPARTMENT, P O BOX 4000, PRINCETON, NJ, 08543-4000, US

(21) Appl. No.: 10/237,448

(22) Filed: Sep. 9, 2002

Related U.S. Application Data
(60) Provisional application No. 60/318,285, filed on Sep. 10, 2001.

(51) Int. Cl. B01F 15/02

(52) U.S. Cl. 366/132

(57) ABSTRACT

Systems and methods for weighing and charging components of a product using a radio-frequency order picking and inventory control system (ROPICS) are disclosed. A system according to the invention can include a server computer having a back-end database for storing inventory data, a client computer that is communicatively coupled to the server computer via a communications network, and a scale for providing to the client computer a weight signal that represents an actual weight of a component on the scale. The server computer includes a data queue for receiving and managing database transaction requests in real-time, and a transaction server for receiving the database transaction requests from the data queue and for interfacing with back-end database to process the received database transaction requests in real-time.

This application claims the benefit of U.S. Provisional Application No. 60/318,285, filed Sep. 10, 2001, hereby incorporated by reference in its entirety.

### FIELD OF THE INVENTION

This invention relates to manufacturing systems. More particularly, the invention relates to systems and methods for weighing and charging components of a product using a radio-frequency order picking and inventory control system.

### BACKGROUND OF THE INVENTION

Frequently, the process of manufacturing a product requires that the components that make-up the product are properly weighed and blended. This is particularly true in the pharmaceuticals industry, where the loss of even a single batch that has been incorrectly weighed or blended can be very expensive.

Sometimes, the manufacturing operator does not know the current status of the components that are available, or the current status of the bill of materials that defines the product to be manufactured. For example, the useful life for a lot of the raw material might have expired, or the lot might have to be re-tested for some reason, or more current information about the component or the product might have become available since the shop order was cut. Similarly, more current information about the component or the product might have become available between the time the component is weighed and the time the components are blended to form the product (or intermediate). Accordingly, it would be advantageous to manufacturers of such products if current, up-to-date information about the products and the components could be made available to the operator in real-time, at the time the components are being weighed and blended.

The weighing and charging processes are also subject to human error. For example, the operator could cause an entire batch to be wasted simply by not weighing a particular component properly before charging the component to the blender. Additionally, since the potency of a particular active ingredient can vary from lot to lot, the operator might need more or less than the theoretical weight of one or more components to achieve the correct dosage for a product. Human error can be introduced when this calculation is performed manually during the weighing process. Accordingly, it would be advantageous to manufacturers of such products if a system of checks were provided that serve to reduce the potential for human error in the weighing and charging processes.

Inventory control systems are sometimes used in such manufacturing environments to provide the manufacturing operator with access to information about the products being manufactured, and the components used to manufacture them. Such inventory control systems, however, typically can be accessed only in batch mode, not in real-time. Thus, these systems do not provide the most current data to the operator. As such a system can only provide data that is current at the time the database was queried, if any time elapses between the time the database was queried and the time the operator performs the weighing or charging function associated with the query, the data can be out-of-date. Additionally, unless the manufacturing operator has the ability to enter data in real-time, the system will not contain the most current data for the materials being used in the weighing and charging process. It would be advantageous, therefore, if the manufacturing operator had real-time access to the most current information in the inventory database, and the ability to update the database in real-time.

Hence, there is a need in the art for systems and methods for weighing and charging components of a product using a real-time inventory control system.

### BRIEF SUMMARY OF THE INVENTION

The invention satisfies the aforementioned needs in the art by providing systems and methods for weighing and charging components of a product using a radio-frequency order picking and inventory control system (ROPICS). A system according to the invention can include a server computer having a back-end database for storing inventory data, a client computer that is communicatively coupled to the server computer via a communications network, and a scale for providing to the client computer a weight signal that represents an actual weight of a component on the scale. The server computer includes a data queue for receiving and managing database transaction requests in real-time, and a transaction server for receiving the database transaction requests from the data queue and for interfacing with the back-end database to process the received database transaction requests in real-time.

A method according to the invention for weighing components of a product can include receiving a shop order identifier associated with the product. Shop order data associated with the shop order identifier is retrieved from a data store. The shop order data is compared to a current bill of materials associated with the product to determine whether the shop order data is consistent with the current bill of materials. If the shop order data is consistent with the current bill of materials, a list of components associated with the shop order identifier is displayed. If the shop order data is not consistent with the current bill of materials, a shop order mismatch indicator is provided.

Another method according to the invention for weighing components of a product can also include receiving a location identifier associated with a manufacturing location. The system determines from the shop order data whether the components that are required to make the product are currently available in sufficient quantity at the location. If the components that are required to make the product are not currently available in sufficient quantity at the location, an insufficient quantity indicator is provided.

According to another method if the invention, a lot identifier that corresponds to a first lot of a first component in the component list is received. Based on the current status of the first lot of the first component, an indicator is provided as to whether the first lot of the first component should be used to manufacture the product. If the current status of the first lot of the first component indicates that the first lot of the first component should not be used, an attempt by an operator to weigh a subsequent component associated with the shop order identifier is disapproved until a subsequent lot of the first component having an acceptable current status is weighed.

Another method according to the invention includes retrieving a theoretical weight for a first (active) component in the component list. A lot identifier that corresponds to a first lot of the component is received, and the system determines a potency for the first lot. A desired weight for the first component is calculated based on the theoretical weight and the potency for the first lot. A representation of the desired weight is provided to an operator of the system. After the first component is properly weighed, the system can retrieve a theoretical weight for a second (compensating) component in the component list. A desired weight for the second component is calculated based on the desired weight for the first component and the theoretical weight for a second component.

Another method according to the invention provides a display that includes a visual representation of a first component from the list of components and a desired weight associated with the first component. The system receives a representation of an actual weight associated with the first component, and accepts the first component if the actual weight is within a predefined tolerance of the desired weight. An inventory data store associated with the lot identifier is updated based on the actual weight of the first component.

A method according to the invention for charging components of a product includes receiving a representation of an actual weight of a weighed-up component from the list of components. The system verifies that the actual weight of the weighed-up component is within a predefined tolerance of an expected weight associated with the weighed-up component. If the actual weight does not correspond to the expected weight, disapproving of an attempt by an operator to charge the weigh-up component.

Another method for charging components of a product includes receiving a lot identifier that corresponds to a weighed-up component from the list of components. A current lot status of a lot corresponding to the lot identifier is retrieved from the data store to determine whether the weighed-up component should be used to produce the product. If the weighed-up component should not be used to produce the product, a lot status alert is provided.

A method for charging components of a product can include receiving a representation that an actual weight of a weighed-up component has been combined with another component used to form a product. A database entry corresponding to the weighed-up component is updated to reflect a reduction in the available amount of the component by an amount that was used to form the product. A database entry corresponding to the product is updated to reflect an increase in the available amount of the product.

Another method for charging according to the invention can include defining a charging sequence for the components such that each component has an associated charging sequence number. The charging sequence providing an order in which the components are to be charged. A component identifier associated with a selected component selected from the list of components is received. From the charging sequence number associated with the selected component, the system determines whether the selected component should be charged. If the selected component should not be charged, the system provides a charging sequence alert.

### BRIEF DESCRIPTION OF THE SEVERAL VIEWS OF THE DRAWING

Other features of the invention are further apparent from the following detailed description of the embodiments of the present invention taken in conjunction with the accompanying drawing, of which:

FIG. 1 is a block diagram of a preferred embodiment of a radio-frequency order picking and inventory control system (ROPICS) according to the invention;

FIG. 2 depicts a preferred embodiment of a server-side processing architecture for a ROPICS according to the invention;

FIG. 3 depicts a sample client dialog with a back-end database using a ROPICS according to the invention;

FIG. 4 is a block diagram of a preferred embodiment of a ROPICS according to the invention that is particularly suitable for weighing and charging components of a product;

FIGS. 5A-5C provide a flowchart of a preferred embodiment of a method according to the invention for weighing components of a product using a ROPICS;

FIGS. 6A-6J depict a preferred embodiment of a user interface for weighing components of a product using a ROPICS according to the invention;

FIG. 7 is a flowchart of a preferred embodiment of a method according to the invention for charging components of a product using a ROPICS;

FIGS. 8A-8L depict a preferred embodiment of a user interface for charging components of a product using a ROPICS according to the invention; and

FIGS. 9A-9C depict a preferred embodiment of a user interface for a Bill of Materials management program for use with a ROPICS according to the invention.

### DETAILED DESCRIPTION OF THE PRESENT INVENTION

A radio-frequency order picking and inventory control system (ROPICS) according to the invention is a system that is designed to enable remote, preferably hand-held, devices to access various functions of SSA's Business Planning and Control System (BPCS), or other such back-end, enterprise requirements planning (ERP) system database. Such back-end databases are well-known and, consequently, will not be described in detail herein.

ROPICS enables operators using remote devices to inquire into inventory, effect inventory transactions, print bar code labels for in-process inventory tracking, weigh and label shop order components, and pick customer orders, for example, without using a remote terminal as is normally required for interfacing with the database. ROPICS is based on the concept of sending individual transactions and receiving responses to these transactions through a series of asynchronous communications mechanisms.

ROPICS includes a server portion and a client portion. Preferably, the client portion includes small, hand held personal computers that provide the user interface. Based on the options chosen and data provided by the operator, the client portion will build the appropriate message transactions and feed these to the server portion. The server monitors for messages being received from the client devices, processes the transactions, and issues the appropriate responses to the requesting devices.

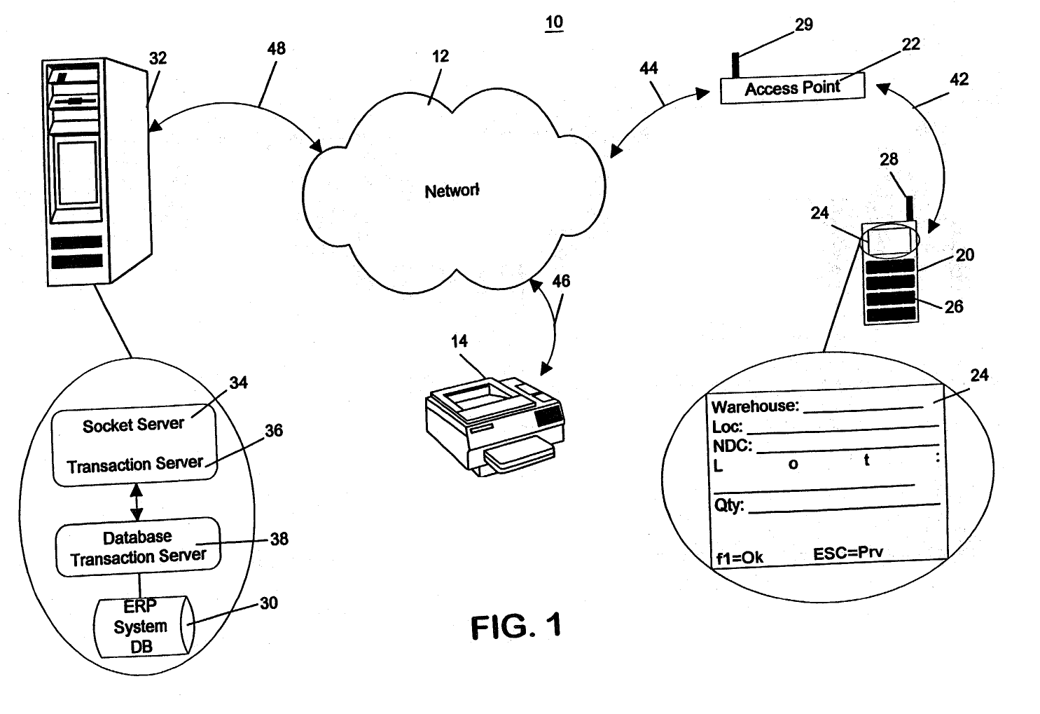

FIG. 1 is a block diagram of a preferred embodiment of a ROPICS 10 according to the invention. As shown, the ROPICS 10 can include a server computer 32 and a client computer (or remote device) 20 that communicate with each other via a communications network 12. Preferably, the communications network 12 is a network based on TCP/IP (transfer control protocol/internet protocol), and can include any local or wide area network, such as an intranet or the Internet. Though one client computer 20 and one server computer 32 are shown in FIG. 1 for the sake of simplicity, it should be understood that a ROPICS 10 can include any number of clients 20 and servers 32. The ROPICS 10 can also include a label printer 14. In a preferred embodiment, the label printer 14 is an Intermec 3400 label printer, which is coupled to the network 12 via a communications link 46.

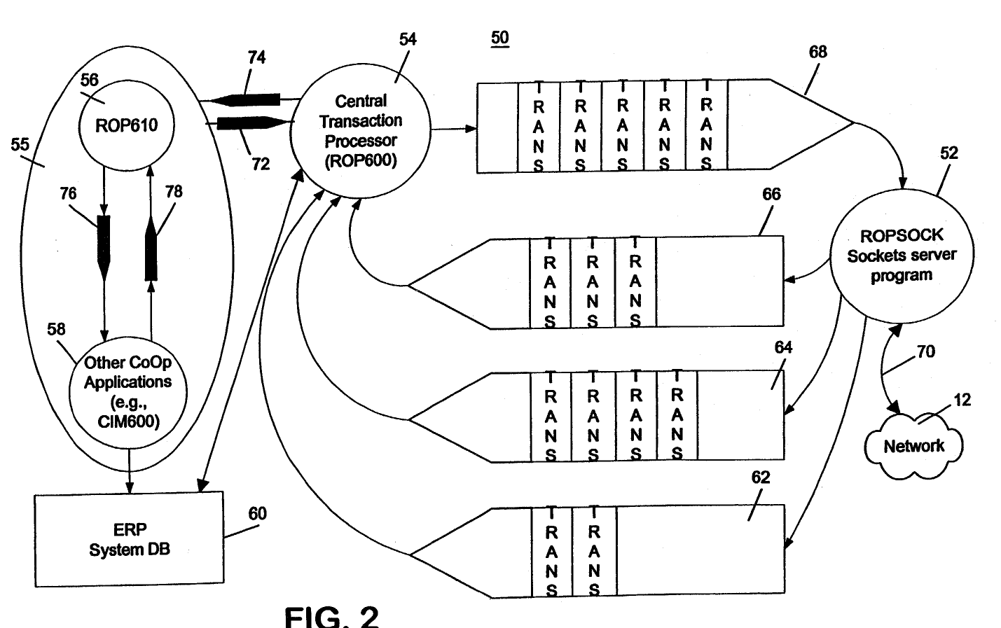

In a preferred embodiment, the server 32 is an IBM AS/400, which is coupled to the network 12 via a communications link 48. The server 32 includes a socket server 34 and a transaction server 36. The transaction server 36 interfaces to a database transaction server 38, which accesses the data store 30. The functions of the server 32 are described in detail below in connection with FIG. 2.

The remote device 20 includes a user input device 26, such as a keypad, and a user output device 24, such as a display. The display 24 displays screens via which the system requests data from the user. In the example shown, the system displays a screen that a user can use to provide the system with data about an item tracked in the back-end database. The display 24 can request that the user provide a warehouse ID, location ID, item number (NDC), lot number, item quantity, or the like.

Preferably, the remote device 20 is a hand-held device, such as an Intermec Janus 2010 or 2020 computer. Alternatively, the client computer 20 can be embodied in a device, such as a Janus 2050, which can be mounted to a piece of equipment, such as a forklift, for example. Preferably, the remote device 20 includes a scanner, such as a laser scanner, for scanning symbols codes, such as bar codes, data matrix codes, or the like, and a symbol interpreter for interpreting the codes to extract data contained in the symbols. In a preferred embodiment, the client computers 20 are 80386-based computers running MS-DOS or WINDOWS, though it should be understood that any suitable processor or operating system can be used. In addition, the units are preferably battery powered, fully portable, and communicate with the host systems through 2-way radio transmissions handled through built-in firmware and device drivers.

Preferably, the client portion of the system includes an access point 22, such as an Intermec 2100 access point. The access point 22 provides the remote device 20 with access to the network 12. In this way, the remote device 20 can be brought anywhere within the signaling range of the remote device 20 to the access point 22, and transmit a signal via its antenna 28 to the antenna 29 of the access point 22. Thus, data can be communicated over the network 12 between the remote device 20 and the server 32.

In a preferred embodiment, PC/TCP Kernel Software from FTP Software, Inc., provides a TCP/IP stack used by the software in the remote device 20 to communicate with the network 12 and, ultimately, with the server computer 32. The client software uses “sockets” as its communication protocol. That is, the client software connects to the server's socket server 34 via the sockets protocol.

The client program, JR500, represents the core of software running on the Intermec Janus PCs. When initiated, the program presents a screen whereby the user can select a server and environment to which to attach. Once this is selected, the system presents a sign-on screen, requesting a user ID and password from the operator. After these are provided, the JR system will transmit a “log in” request to ROPICS.

If the user ID and password are correct and are found in the server's security database as well as in the back-end database and ROPICS security, then the user will be allowed into the Main JR Menu, from which various functions may be selected. These include P.O. and DRP Receipts, Inventory Transfers and Inquiries, Customer Order Picking, Cycle Counting, QA Adjustments, and manufacturing issues and receipts. In general, each time the user fills in the appropriate fields on a JR screen and presses enter, a transaction is built and transmitted to ROPICS, which will service the transaction and reply back to JR with appropriate result codes indicating success or failure (along with reason, if failure). The JR system will evaluate the response and then inform the operator of the status of the transaction.

Preferably, the ROPICS Main Menu includes options for Inventory, Receiving, Counting, Order Processing, Label Printing, Manufacturing, and Admin. The Inventory Menu includes options for Put Away, Transfer, Replenish, Adjust, Inquiry, and Location/Kit Transfer. The Inquiry sub-Menu includes options for Lot Inquiry, Location/Kit, Purchase Order Inquiry, and Pegging Inquiry.

The Receiving Menu includes options for Distribution Requirement Planning (DRP) Receipt, Standard Receipt, Purchase Order (PO) Receipt, and PO Inquiry. The Counting Menu, which is used to maintain inventory record accuracy, has no options. The Order Processing Menu includes options for Current Orders, Download Orders, and See Order Status. The Label Printing menu includes options for Pallet Labels, Pick aisle Labels, Material Labels, Work in Process (WIP) Labels, Pre-Weigh Labels, Kit Labels, Operation Labels, Miscellaneous Labels, and Dispatch Pallet Labels. The Manufacturing Menu includes options for Weigh-Up Shop Order (SO), Weigh-Up Campaign, SO Issues, SO Receipts, Record Labor, Reconcile Warehouse/Location, SO Scrap, and Reprint Kit List. The Admin Menu includes options for Exit to DOS, and Message to other HH.

FIG. 2 depicts a preferred embodiment of the server side processing architecture 50 for a ROPICS according to the invention. Basically, the programs depicted in FIG. 2 are background jobs that run perpetually on the server computer and either service requests from client processes (e.g., hand held computers running ROPICS) or help to maintain shop order inventory pegging files. In a preferred embodiment, ROPICS includes a sockets server 52, a central transaction processor 54, and one or more processing programs 55. The processing programs 55 communicate with one another via data queues, such as via data queues 76, 78 as shown.

The ROPICS Sockets Server (ROPSOCK) 52 is a computer program, preferably written in C, that runs on the server. ROPSOCK 52 provides the “middleware” communications, over the network 12, between the client devices 20 and the ROPICS processor 54 on the server. ROPSOCK 52 listens for incoming connections over the TCP/IP network 12. When a connection request comes in, the program assigns a socket to this connection and begins sending to and receiving from the client system through this socket. Transactions received on the socket are placed on a data queue 62, 64, 66 for processing by the ROPICS central transaction processor 54. Though three data queues are shown in FIG. 2, it should be understood that any number of data queues can be used. Replies from ROP600 54 are placed on an outgoing data queue 68 and will be picked up by ROPSOCK 52 and forwarded on to the correct device via its socket connection. ROPSOCK is coupled to the network 12 via a communications link 70.

The Central Transaction Processor (ROP600) 54 is the “heart” of the ROPICS system. This program can be thought of as a central traffic cop for all communications. ROP600 54 constantly monitors its data queues 62, 64, 66, which carry transactions arriving from the remote devices. When a transaction arrives, it is analyzed for validity, security, and function. Depending on the results of this analysis, ROP600 will do one of four things.

1. If the transaction contains any intrinsic errors (e.g., non-numeric data in numeric field), ROP600 will immediately send a reply to the device indicating the nature of the error.

2. If the transaction is either explicitly addressed to another device or another program, or if the transaction can be best served by another program, ROP600 will forward it to that device or program. For instance, a device may issue a transaction asking the Inventory Transaction Server program 58 whether it is currently running or not. In this case, ROP600 will place the transaction into CIM600's incoming data queue 76. In another case, the transaction may be requesting a transfer of inventory in the back-end data store. This type of transaction, though not explicitly addressed to CIM600, will cause ROP600 to append all of the necessary information to the message and issue it to CIM600, whose job it is to handle inventory transactions. Similar to CIM600 58, in terms of being a cooperative application which processes certain types of transactions, is ROP610 56, to whom certain hand held requests are forwarded (such as label printing requests) via data queue 74.

3. The third way in which a transaction may be handled occurs for relatively simple transactions, specific to ROPICS. In these cases, ROP600 54 will perform the necessary research for building a response to the transaction, and will reply directly back to the device. An example of this type of transaction is when a device inquires into the status of a lot in inventory. ROP600 will retrieve the lot, fill in the necessary fields in the reply, and issue the response to the device.

4. The final action ROP600 may take on an incoming transaction is to queue it up until all of the pages of the transaction are received. For example, the “pick customer order” transaction includes multiple pages. Since ROP600 receives these pages one-at-a-time, each page must be saved until all pages have been received. When the final page is received, the queued up pages are re-retrieved and all are then processed.

In addition to looking for messages from devices, ROP600 also looks for replies to previous requests from CIM600 and other cooperative applications on data queue 72. When these replies are received, ROP600 will repackage them in a way that the device can understand, and then forward the reply to the correct device via data queue 68.

Besides the up-from-devices queue, and the reply-from-CIM600 queue, ROP600 can also monitor a data queue (not shown) that is used for maintenance requests by the ROPICS system administrator. For instance, in order to cause ROP600 to stop running, an exit program message is placed in its maintenance queue.

The purpose of the CIMPATH Transaction Processor (CIM600) 58 is to process back-end inventory transactions. Preferably, the transaction processor 58 is a modified version of a transaction processor that is included in the BPCS package. Before the ROPICS change, CIM600 worked by processing large batches of transactions found in the Inventory Transaction Work File (NIN) of BPCS. The process flow was as follows:

1. Read next NIN record (if end of file, go to end of program).

2. Perform edit checks to ensure transaction valid.

3. If invalid, write error line to audit log report and go back to the top of the loop.

4. If a valid transaction, update all of the necessary BPCS database files.

5. Delete the NIN record just processed.

6. Go back to the top of the loop.

In ROPICS, all sorts of inventory transactions are handled “on-the-fly,” i.e., as they occur. Accordingly, an online (or “real-time”) version of CIM600 was developed. Changes were made to CIM600 to allow it to get its transactions to process either from the NIN file (traditional approach preserved) or from a data queue as they arrive (ROPICS mode). Therefore, the modified version of CIM600, if called in the traditional way, performs exactly as before. If CIM600 is called in ROPICS mode, it will go through the following steps:

1: Instead of reading NIN file, receive next transaction from data queue.

2: Perform edit checks to ensure transaction valid.

3: In addition to writing an error to the log report, reply to ROP600 that the transaction failed, along with the reason code for failure.

4: If a valid transaction, update all of the necessary BPCS database files.

5: Instead of deleting NIN record, issue a “success” reply to ROP600 for the transaction.

6: Go back to the top of the loop.

The ROPICS Cooperative Processor 56 (ROP610) is designed to offload some of the processing for ROP600 by handling transactions that may take a little longer to complete than others. For instance, when ROP600 receives a “print label” transaction, it simply forwards this on to ROP610 to process (via data queue 74). The sort of transaction is forwarded to ROP610, because, in a preferred embodiment, ROPICS employs a label printing program, such as TL Ashford, to provide the label format to printer. Consequently, this process may take an undetermined amount of time to complete (not necessarily a long time, but simply an amount of time that is outside the control of ROPICS). Typical transactions that can be handled by ROP610 include: Request pending transfers, Print bar code labels, Inventory transfers (only mass transfers by location or kit. Single transfers are handled by CIM600), and Post labor transaction. ROP610 responds to ROP600 via data queue 72.

In a preferred embodiment, ROPICS also includes a number of other cooperative programs (not shown explicitly in FIG. 2) that run on the server computer. For example, the ROPICS Pegging Processor (ROP620) helps facilitate selecting the correct lot of raw materials or components to be used in a shop order. ROPICS includes several programs that are designed to keep an up-to-the-minute view of inventory and shop orders that need it (so-called “pegging”). A trigger program (ROP621) is placed on certain files that relate to items, lots, shop orders, or inventory. This program simply forwards, via data queue, any adds/changes/deletes of these files to ROP620, which then updates an inventory availability file, RPILI, and calls ROP620 to make any updates to a pegging file, RPELA. Through this approach, the RPELA file shows, at any given time, which lots in which locations should be used for each shop order line in the system. Of all of the background jobs covered in this section, this is the only one not involved with the processing of client transactions.

The ROPICS Control Processor (ROP600C) (not shown) is a multi-purpose program which is mainly used to initiate ROPICS background programs (ROP600, ROP610, ROPSOCK, ROP620 and CIM600) and to end them, depending on a parameter passed to the program. In addition, the program performs all of the necessary validation of the system state before it initiates ROP600. For example, it will check that the necessary data queues exist, creating them if not found.

The ROPICS Main Menu program (ROP000C) is the central menu for ROPICS. It displays all of the server-accessible programs, such as ROP600C, maintenance programs, report programs, access to related menus, etc. This program also serves as the security officer for server program access. That is, when an option is selected in the ROP000C menu, the program will first check to see that the user has an entry in the ROPICS security file for that program. In order to access a program found in this menu, the name of the program (first six characters) must be found in the ROPICS security file, which is maintained through a Security File Maintenance program (ROP102C). The only variation on this security scheme is that, in order to be able to access ROP102C, the user must have an appropriate entry in the database's security system. Preferably, access to this option is limited to designated ROPICS security officers.

Preferably, the ROP000C menu includes two menus: a distribution-oriented menu and a manufacturing-oriented menu. If a certain system parameter, ROPMENU, is set to a value of DIST, then the distribution-oriented menu will appear. If ROPMENU is set to MFG, then the manufacturing-oriented menu will appear. Pressing F11 on either of these menus will toggle to the other.

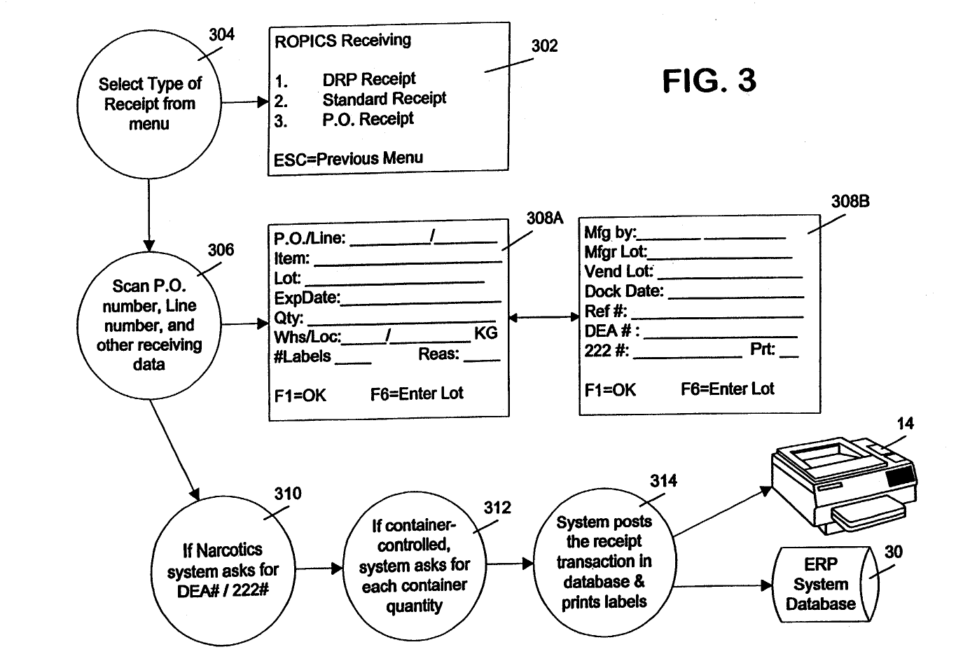

FIG. 3 depicts a sample client dialog with a back-end database using a ROPICS according to the invention. As shown in FIG. 3, the system can provide a display 302 at the remote device. The display can provide one or more options that the operator can select to cause the system to perform certain functions associated with inventory control. In the example shown in FIG. 3, the system provides a display 302 of a receiving menu having options for DRP receipt, standard receipt, and P.O. (purchase order) receipt. The operator might request the receiving menu to provide information to the inventory database concerning the receipt of materials into the plant.

As shown, the operator can select an option from the menu at step 304. As shown, the operator can select “2. Standard Receipt” from the Receiving menu display 302. Then, at step 306, the system provides a Standard Receipt display having two pages 308A and 308B. The operator provides the purchase order number, line number, and any other requested Receiving data relating to the item being received. Preferably, the operator provides some or all of the requested information by scanning a symbol code on a purchase order associated with the receipt.

If the item being received is a “Schedule 3” item to be used in a narcotics system, the system, at step 310, requests the DEA# and 222#, which the operator provides. If the lot is to be container-controlled, the system, at step 312, requests the quantity of materials in each container in the lot. At step 314, the system posts the receipt transaction in the back-end database 30 and prints labels from the label printer 14. The labels include a bar code or other such symbol code that identifies the lot of the received product.

As the lot is moved through receiving to storage to weighing and charging, and ultimately through shipping, each lot of raw material, manufactured product, and other such inventory item is tracked by bar codes on labels associated with the items. Every time an item is moved, or some action performed with respect to the item, the operator scans the bar code and provides up to date information to the system. The system maintains the database in real time (i.e., as data is provided), so that the system has access to the most current status of items being tracked through the inventory control system.

Systems and methods for weighing and charging using a ROPICS according to the invention will now be described. A portion of such a system that guides the operator through the weighing and charging processes, and provides the operator with a user interface to the back-end database is known as “ROPICS Weigh.” The original ROPICS system (see FIG. 1) was designed as a remote-client system using Radio Frequency connected terminals. The ROPICS Weigh client, however, runs on standard IBM PC compatible desktop machines. The host communication section is the same (from the server end). A perpetually running sockets server program, ROPSOCK, resides on the server and fields transaction packets arriving from a client. The client can be an Intermec Janus hand held computer or a Windows NT 4.0-based PC running ROPICS Weigh, for example. Each of these packets is forwarded to the central ROPICS transaction processor, ROP600. Based on the nature of the request, ROP600 will build an immediate response and will either pass it to ROPSOCK for forwarding to the client, or it will pass it on to one of a number of “helper applications” which will build the appropriate response. For instance, inventory transactions are bundled by ROP600 and passed on to CIM600 for processing.

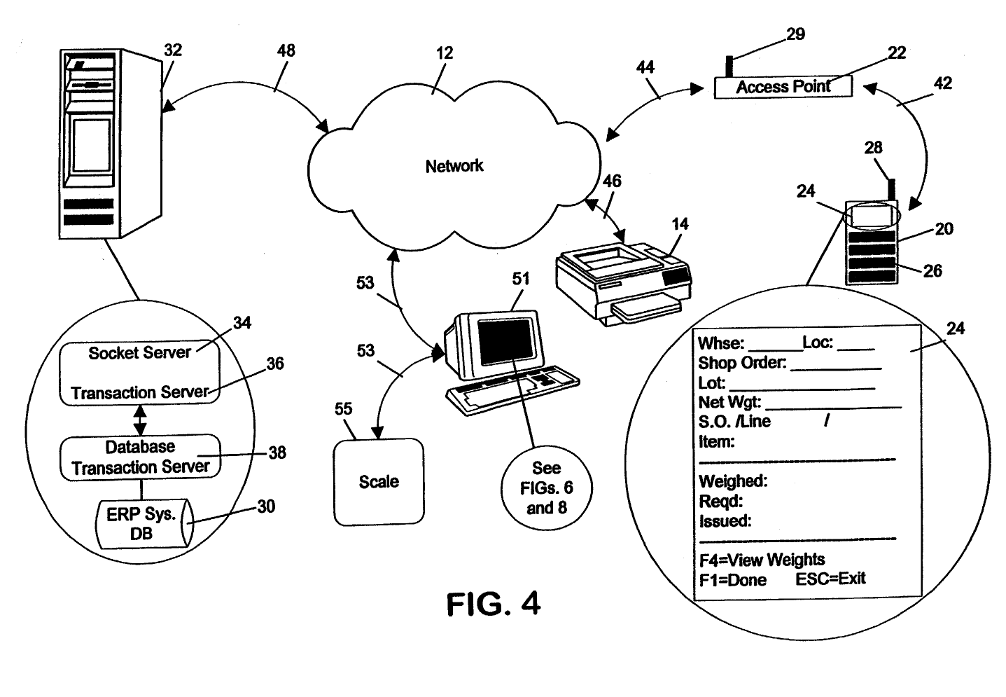

FIG. 4 is a block diagram of a preferred embodiment of a ROPICS according to the invention that is particularly suitable for weighing and charging components of a product. As described above in connection with FIG. 1, where like reference numerals have been used to designate like components of the system, a ROPICS can include a server 32 having a socket server 34, transaction server 36, database transaction server 38, and back-end ERP data store 30. The server can be coupled to a TCP/IP network 12 via a communications link 48. The system can also include one or more remote devices 20, each having a data input device 26, display 24, and RF antenna 28. The remote device 20 is coupled to the network 12 via an access point 22 having an antenna 29 for receiving RF signals from the remote device 20 over a communications link 42. The access point 22 is coupled to the network via a communications link 44. The system can also include a label printer 14 that is coupled to the network via a communications link 46.

As shown in FIG. 4, a ROPICS according to the invention can also include a personal computer 51, which is preferably an Intel PC, that is coupled to the network 12 via a communications link 53. A scale 55 is coupled to the PC 51 such that the scale 55 can provide weight signals to the PC via a communications link 57. The weight signals represent the actual weight of whatever is currently on the scale. Preferably, the PC 51 includes a central processing unit (CPU), a hard drive, a display, a keyboard, a mouse, and a bar code scanner.

The ROPICS Weigh system is designed to automate the raw material weigh-up, check, and charge functions that are performed in the manufacturing area. As part of the system, the Bill of Material editing and approval functions were enhanced and secured on the server. That is, information that resides on Working Formula Procedure paperwork can be stored electronically in a Bill of Material file on the server. This information is transferred to each shop order when it is cut. Then, when an operator begins the weigh-up function for an order, he or she can scan the shop order number into a ROPICS Weigh PC in the manufacturing area, which will request that all of the relevant information on the order be transferred to the PC. This information includes technical specifications about each ingredient that will determine exactly how its required quantity should be calculated, and the order of weighing and charging operations.

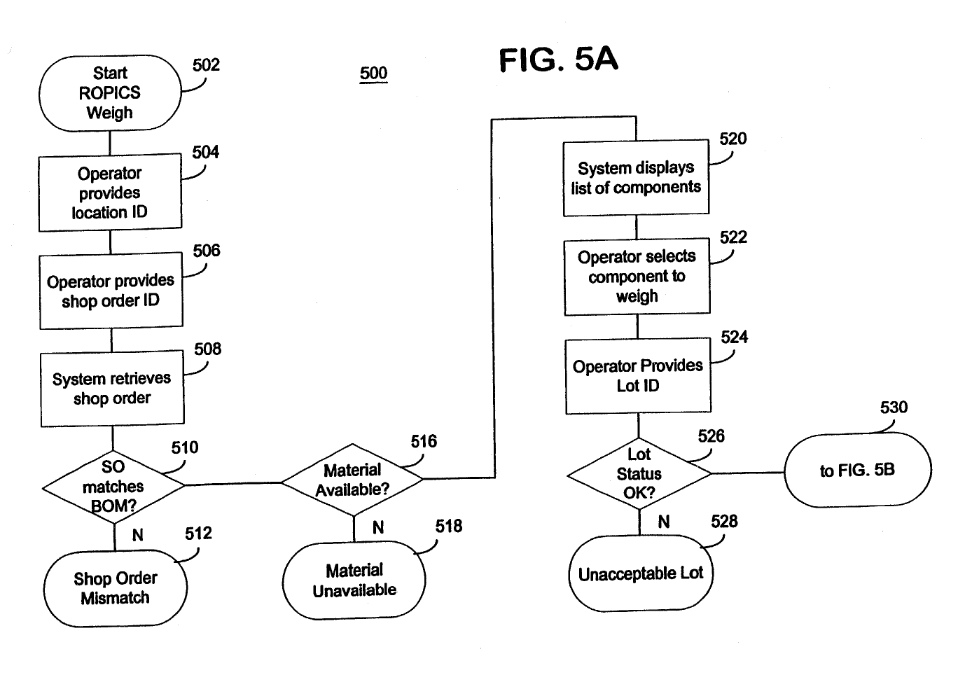

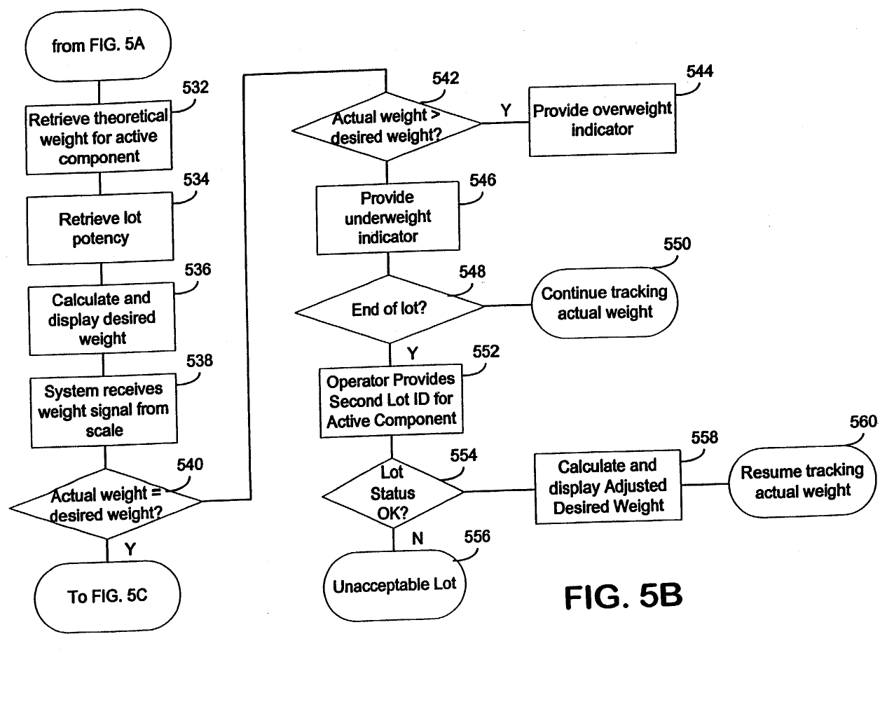

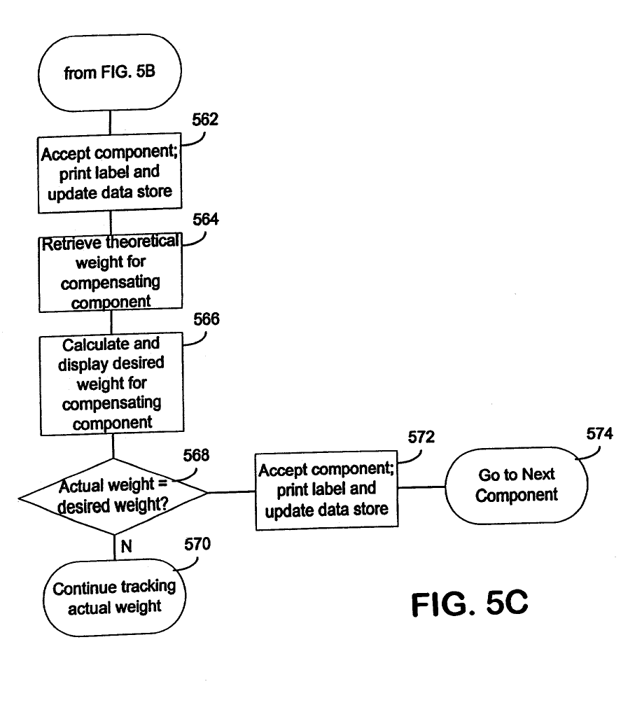

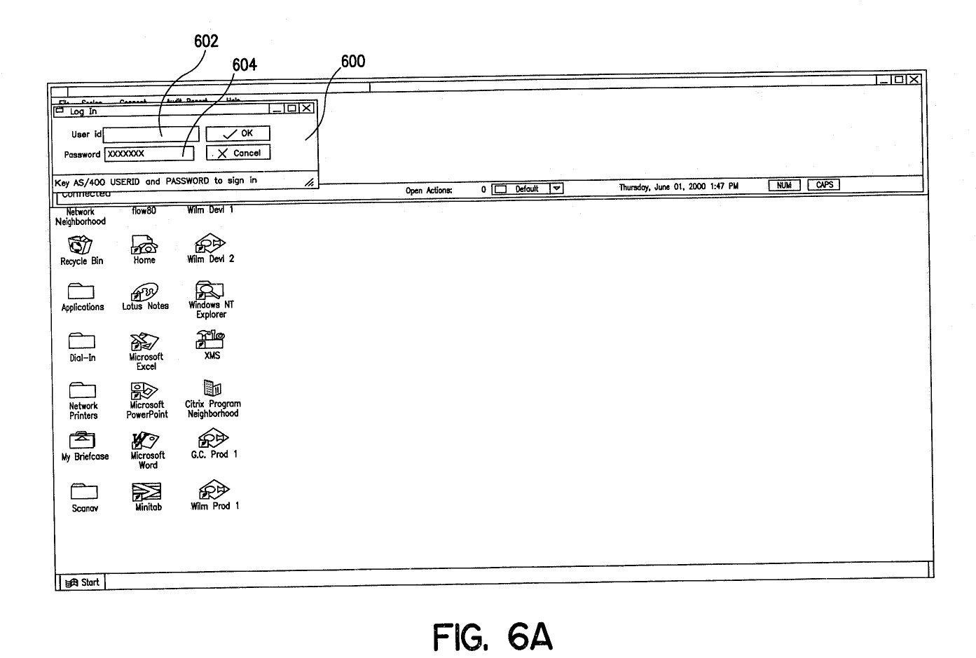

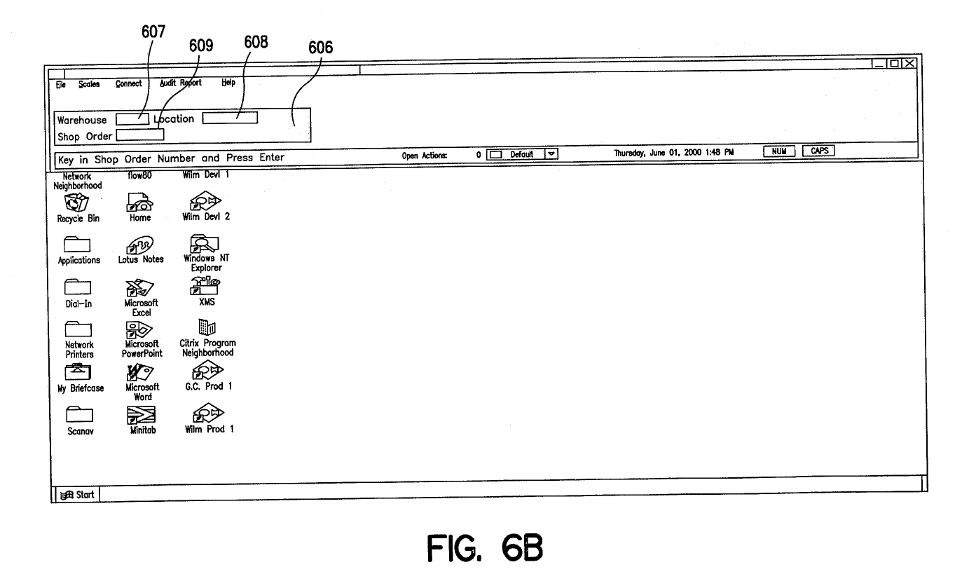

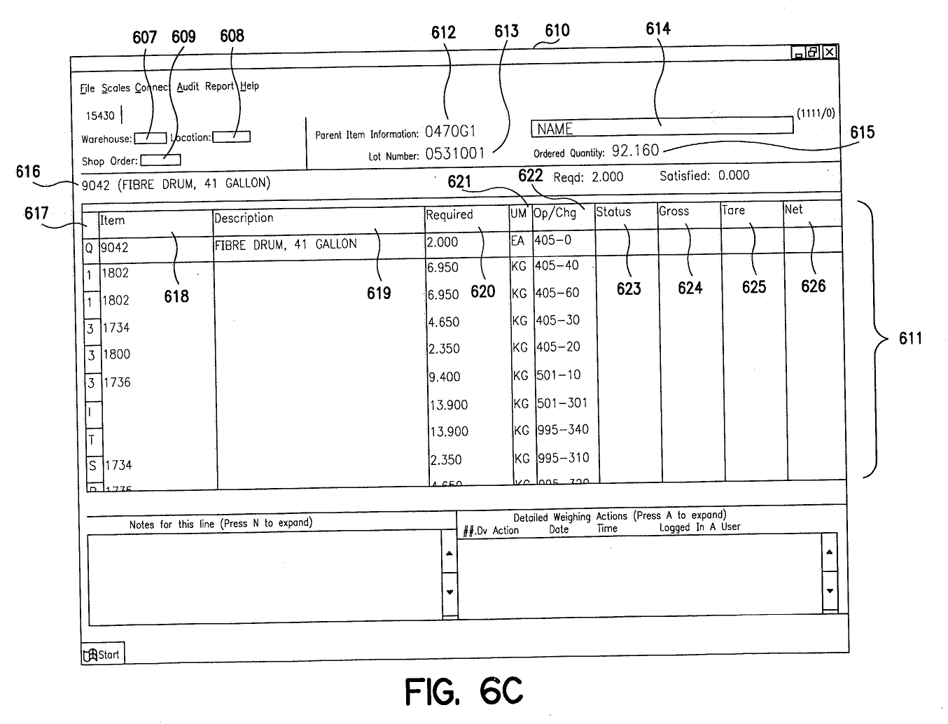

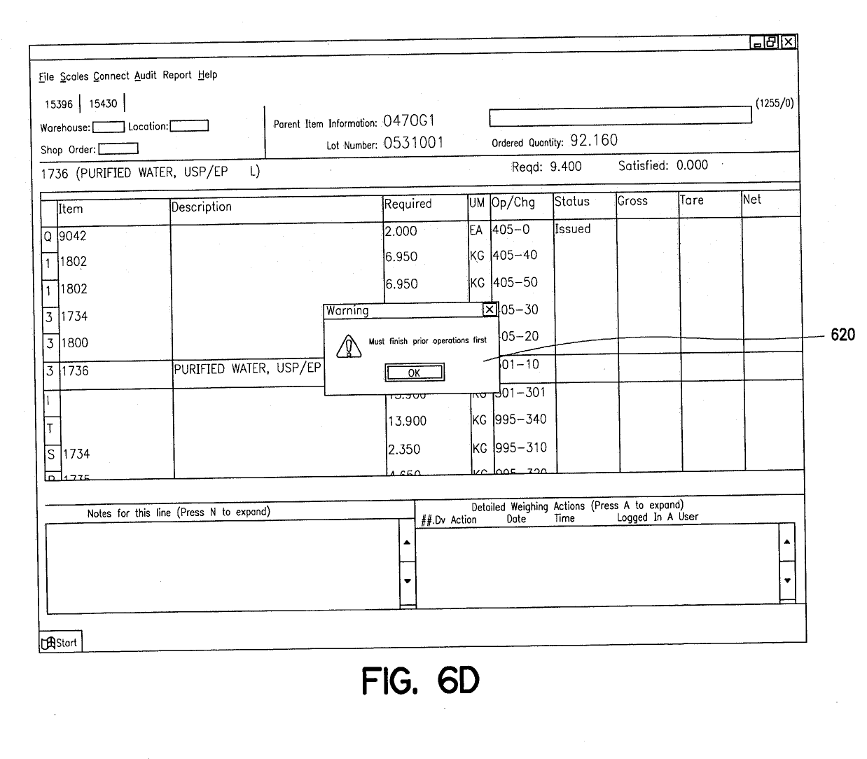

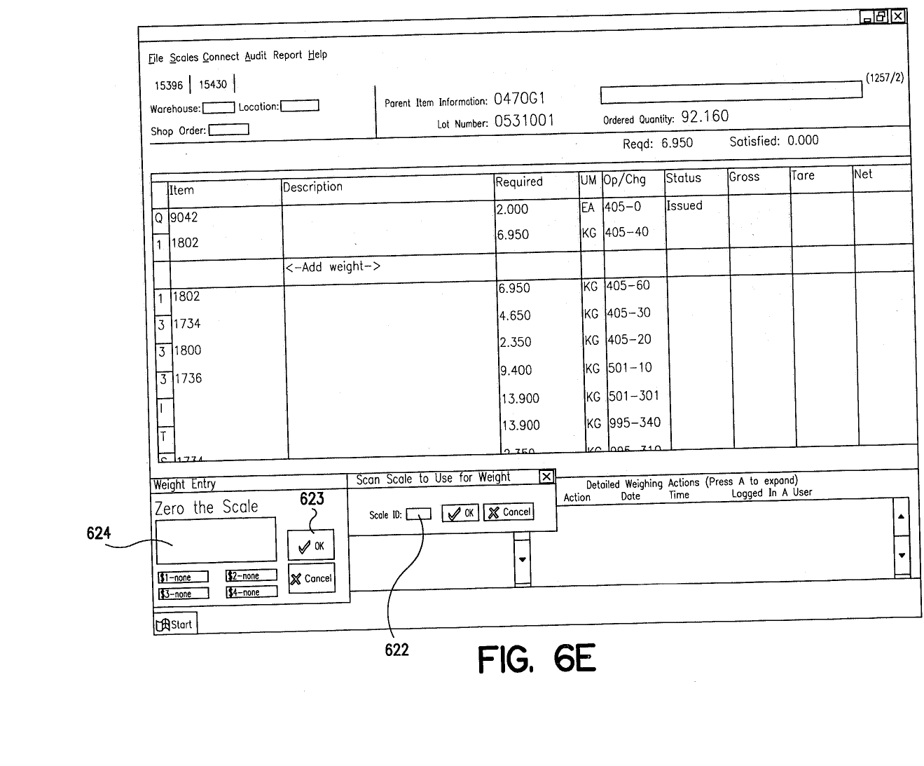

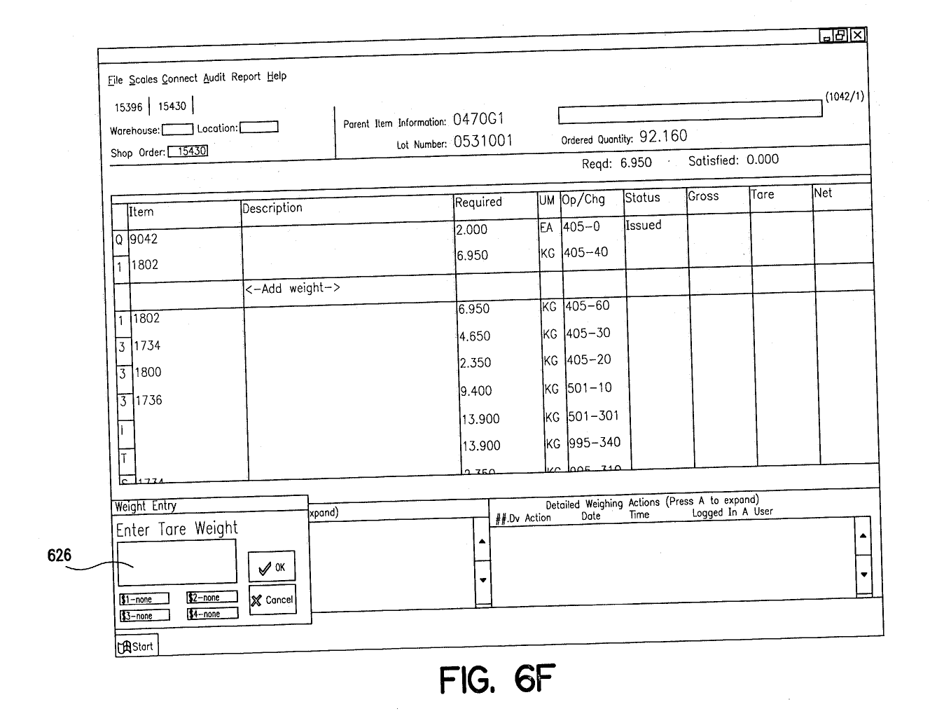

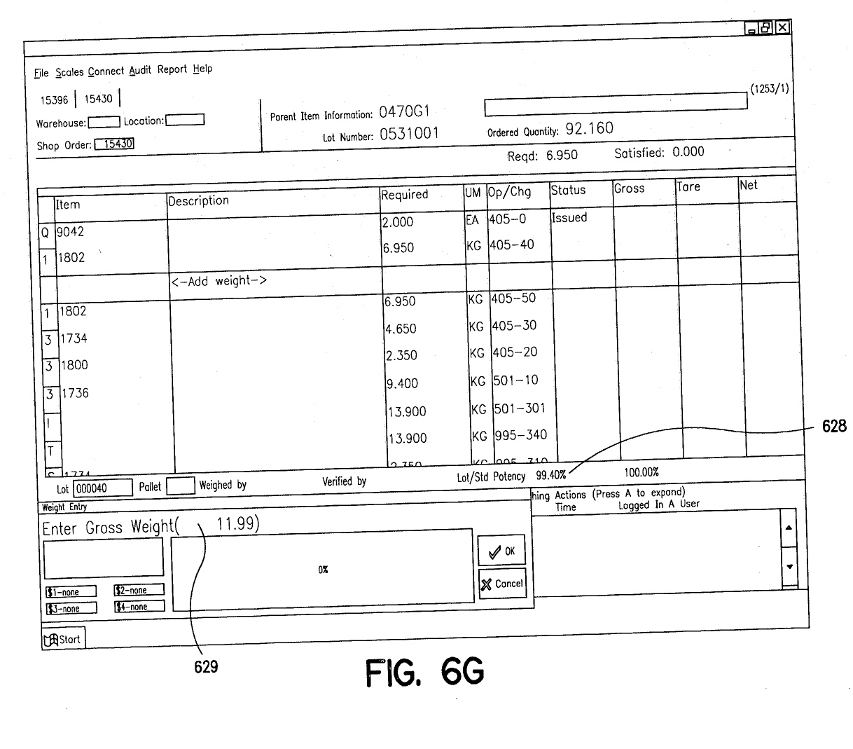

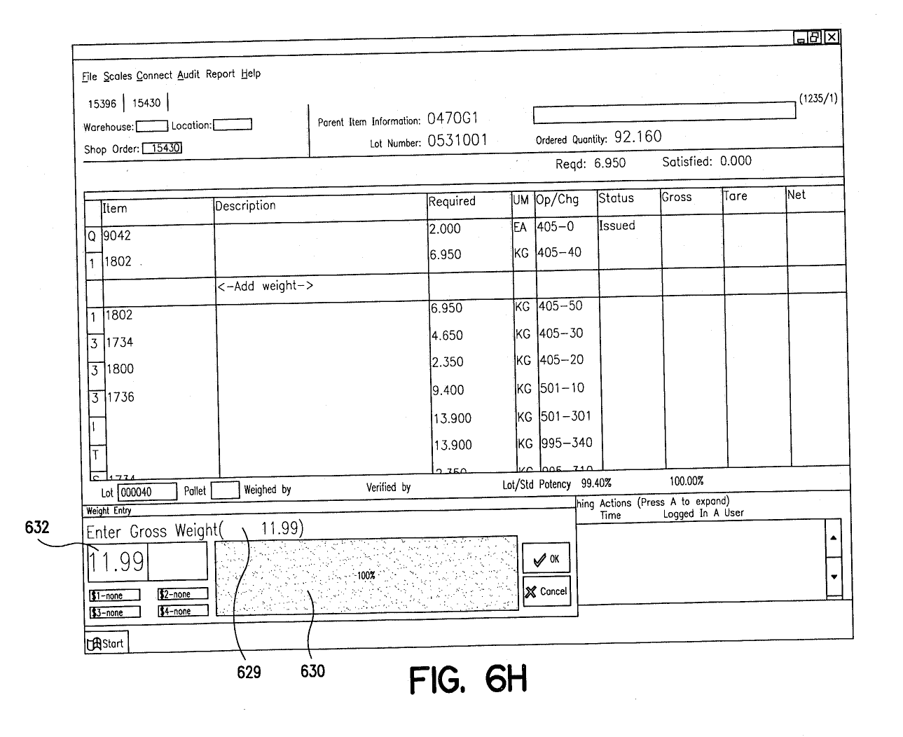

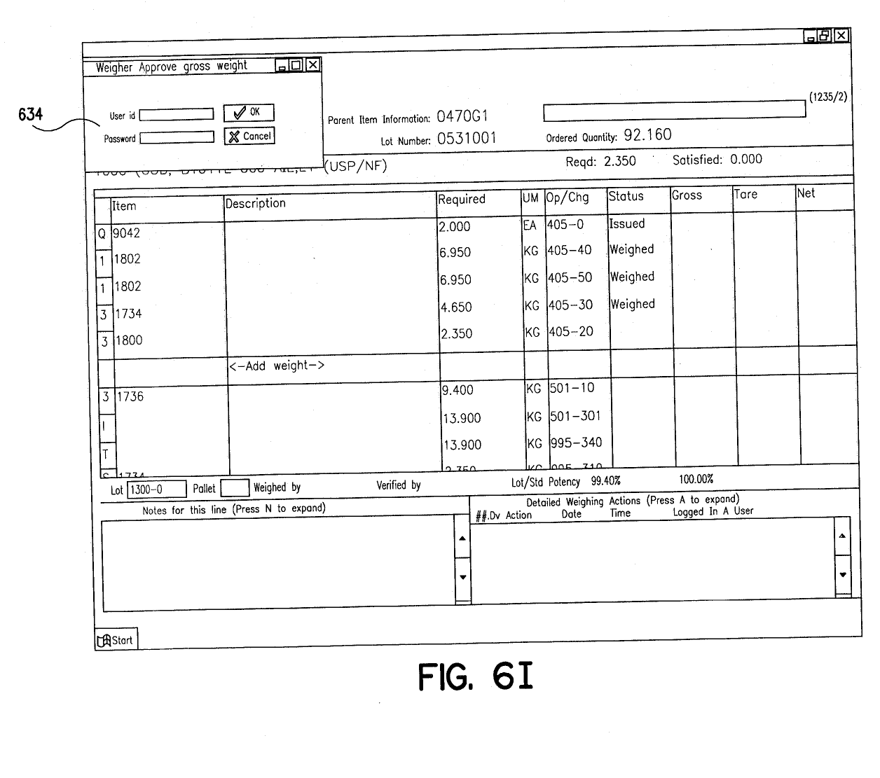

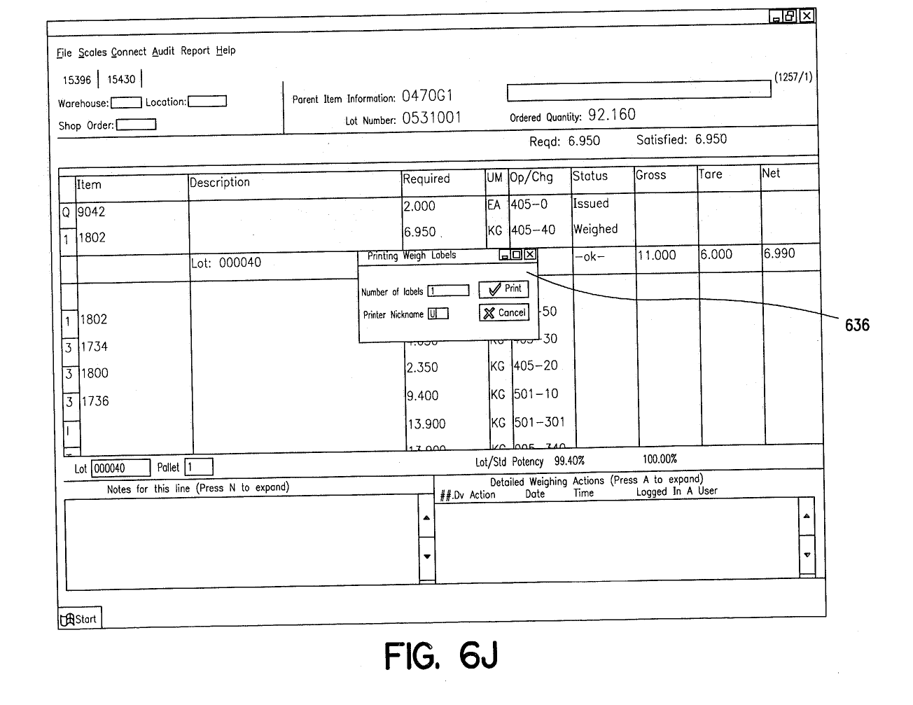

Systems and methods according to the invention for weighing components of a product using a ROPICS will now be described in connection with FIGS. 5 and 6. FIGS. 5A-5C provide a flowchart of a preferred embodiment of a method according to the invention for weighing components of a product using a ROPICS. FIGS. 6A-6J depict a preferred embodiment of a user interface for weighing components of a product using a ROPICS according to the invention.

As shown in FIG. 5A at step 502, the operator logs on to the ROPICS weigh program at the ROPICS Weigh PC. FIG. 6A depicts an exemplary log-on screen 600 that includes a user ID entry field 602 and password entry field 604. The user is required to provide a valid user ID and password. The system accepts the user ID and password and searches the database to determine whether the user ID is present, and, if it is, the system determines whether the password matches the user ID. If an invalid user ID or password is entered, the system will not allow the user to proceed. Preferably, the user can enter the user ID and password using an encrypted token, which is basically a bar code symbol that represents the user id/password. During a session, the user can print a bar code symbol that corresponds to the user ID password combination. Thereafter, the user can simply scan the symbol (which can be affixed to the user's badge, for example) any time the user is asked to enter his user ID and password. Thus, the user ID and password can be used as the user's electronic signature where desirable. In such an embodiment, the user is required to manually enter the password on the first use for the session.

At step 504, the operator provides the system with a location ID that corresponds to the location at which the weighing process is to take place. The database includes a list of allowable locations. FIG. 6B depicts a user interface 606 having a warehouse data entry field 607, a location data entry field 608, and a shop order identifier data entry field 609. The user can enter a warehouse ID and weighing location via the user interface 606. Preferably, the system defaults to the last entry that was made, presuming that a given operator will likely be at the same warehouse and location each time he uses the system.

At step 506, the operator provides the system with a shop order ID. In a preferred embodiment, the shop order ID is a number. It should be understood, however, that the shop order ID can be any alphanumeric or symbolic string. The operator can use the PC's laser scanner to scan from the shop order a bar code, or other such symbol code, that contains data corresponding to the shop order identifier. Alternatively, the user can manually enter the shop order ID into the shop order identifier data entry field 609.

At step 508, the system retrieves from the back-end database a shop order that corresponds to the shop order identifier. At step 510, the system determines whether the shop order is compatible with the current Bill of Materials (BOM) associated with the product to be made. The system performs this check because the BOM might have changed since the shop order was cut in such a way that the shop order should be different based on the changes made to the BOM. In contrast to known systems, a system according to the invention has real-time access to the most current BOM information. Therefore, if the BOM changes after the shop order is cut, the operator can be so advised before the batch is made.

If, at step 510, the system determines that the shop order is no longer compatible with the BOM, then, at step 512, the system issues a shop order mismatch alert. The system can provide a visual or audible alert, for example, that indicates that the shop order is no longer valid because it does not match the BOM. Preferably, if a shop order mismatch is detected, the system will not “download” the shop order. That is, the system will not display the list of components required to manufacture product in accordance with the shop order (see description of step 520), and thereby prevent the operator from continuing with the weighing process. In this way, the system prevents the operator from making a batch of the product using an outdated shop order, and thereby prevents the batch from being wasted.

If, at step 510, the system determines that the shop order is compatible with the current BOM, then, at step 516, the system determines whether enough of each ingredient is present at the location to prepare the batch. For each component, the system retrieves from the database, an indication of the current availability of the component at that location. If any component is not available in sufficient quantity (based on the theoretical weight of the component that is needed to fill the shop order), the system, at step 518, provides a material unavailability alert. This alert gives the operator a warning that there is an insufficient quantity of one or more components at the location. Consequently, the operator can order more material, if necessary, before the weighing process begins.

If, step 516, the system determines that enough of each ingredient is present at the location to prepare the batch, then, at step 520, the system downloads the shop order to the ROPICS Weigh PC. FIG. 6C depicts a ROPICS weigh display 610 after the shop order has been downloaded. At this point, the system “locks” the shop order. That is, the system does not allow any changes to be made to the shop order after it has been downloaded.

The display 610 displays the warehouse ID 607, the location ID 608, and the shop order ID 609. The display 610 can also provide “parent item” information. The parent item, as that term is used herein, represents the blend of ingredients. The term “child items” refers to the ingredients themselves. The parent item has its own item number 612, and the system may assign each lot of the parent item its own lot number 613. Alternatively, the lot number of the parent can be assigned manually. The display 610 can also include a parent name 614 and ordered quantity 615 of the parent item.

The display 610 can also include a components list 611. For each component (or “weigh line”) in the list 611, the display provides a usage code 617, an item number 618, and a description 619. The display 610 also indicates a quantity 620 of the component that is required for the weigh line and the units 621 in which the quantity 620 is expressed. The quantity 620 is the theoretical quantity of the component that is required before any adjustment is made for potency, compensation, or the like.

Preferably, the display 610 includes a charging sequence code 622 for each weigh line. The charging sequence code 622 indicates the order in which the components are to be charged to the blender. The display 610 also provides fields for the current status 623, gross weight 624, tare weight 625, and net weight 626 of each component.

Typically, a product is manufactured from a number of raw materials, each of which is carefully weighed and blended together to form a “batch.” Batches for orally administered dry products, such as tablets and capsules, are often referred to as “granulation batches.” A typical granulation batch includes an Active Drug Substance (ADS), along with other ingredients, such as fillers and colors. All of these ingredients must be measured precisely and consistently, so that each batch that is manufactured will be uniform with the specifications that were originally tested in clinical trials and later approved by regulatory agencies, such as the US FDA.

One complicating factor is that a certain item may be subject to lot-by-lot variations in potency. Consequently, the actual amount of the item added to a batch can, in general, be expected to vary based on which lots are used to manufacture the batch. This potency variation occurs most importantly for the ADS, but also may occur for other key ingredients such as color additives. Furthermore, when more of one ingredient, such as the active drug substance, is added to the batch, the amount of a “compensating” ingredient must then be decreased, so that the total batch size remains the same. The way that each ingredient is measured and adjusted for the batch is referred to in the ROPICS Weigh as the item's “usage code”.

Usage Code 1 Adjusted for Potency.

Active Drug Substances and some colors that vary in their potency must be adjusted so that the effective strength of the substance remains consistent from batch to batch. Consider the following example. A typical batch of a product has a batch weight of 552.96 Kg and contains 216 Kg of an ADS. This 216 Kg, however, is the theoretical amount of the ADS to include if the raw material lot is 100% potent. Most lots of ADSs, however, are somewhat less than 100% potent. So, if a lot is used which is only 90% potent, the batch would need 216 Kg/0.90=240 Kg of the ADS instead. Thus, the desired weight, W_{d}, for a usage code 1 material is the theoretical weight, Wₜ, times the ratio of the item standard potency, Pₛ, to the lot potency, Pₗ. That is, W_{d}=Wₜ(Pₛ/Pₗ).

Normally, item standard potency will be 100%, but does not necessarily have to be. Some colors have a standard that is less than 100%. So, for example, if a particular ingredient has a standard potency of 40% and the lot's potency is 35%, then the required weight would be multiplied by (0.40/0.35) to arrive at the actual amount to weigh.

Often the current raw material lot in use will be exhausted before the line is completely weighed. In such cases, the line will require some of one lot and some of another. Once the first lot is exhausted, the system will calculate the effective satisfied weight using this lot and subtract this from the required quantity to yield the new required quantity for lot 2. For example, consider lot A has a potency of 90% and lot B has a potency of 95% (assume 100% is the standard item potency). The theoretical required quantity, say, for the item is 10 Kg. Finally, assume that only 5 Kg of lot A is available at the start of weighing this line.

After weighing 5 Kg actual of lot A, the system calculates that this lot has satisfied 5 Kg×0.90=4.5 Kg. The original required quantity is 10 Kg, so with 4.5 Kg satisfied, there remains 5.5 Kg (i.e., 10−4.5) to be satisfied. So, when lot B is indicated, the system will then calculate how much of it is required, which will be: 5.5 Kg /0.95=5.79 Kg required (rounded to accommodate a B class scale). ROPICS Weigh will allow for an unlimited number of lots to be combined to satisfy a line item, using the same general calculation technique shown here to determine how much of each lot to require.

Usage code 2 Compensating Item.

Any batch that contains one or more potency-adjusted items (usage code 1), will need other item type(s) to make up for the fact that adding more (or less) of the adjusted item will change the batch size if some other item(s) are not also adjusted. The most common, and simplest, form of these is referred to as a “compensating item” and has usage code 2.

Suppose that the manufacturer is trying to make 20 Mg tablets of a certain drug substance, whose granulation batch size is 500 Kg. Now, given the fact that each of the tablets weighs exactly 10 grams, a standard batch will yield: 500 Kg/0.010 Kg/Tablet=50,000 Tablets. One fixed quantity in this process is the size of the tablet. This cannot be allowed to change. So, in the example batch, the total amount of dosage is divided among 50,000 tablets or, stated another way, the batch makes 50,000 doses of the drug. Now, if the lot of the active drug substance is less than 100% potent, more of the ADS will have to be added to the batch in order to still provide the required strength for 50,000 doses. Suppose that an additional 20 Kg of the ADS must be added to achieve the required strength. Unless an adjustment is made to another component, the resultant granulation batch will weigh 520 Kg. Since the tablet is a fixed size (e.g., 10 g), the 520 Kg granulation batch will produce 520 Kg/0.010 Kg/Tablet=52,000 Tablets.

Since the batch still only has 50,000 doses, but is divided among 52,000 tablets, then each tablets will have slightly less than the 20 Mg of strength desired. An ingredient with usage code 2, a so-called compensating item, can be used to correct for this.

In the example above, suppose that, in addition to the type 1 active ingredient, one of the other components is a type 2 ingredient. This will typically be an inert ingredient that has no affect on the patient (e.g., lactose, which is a form of sugar). Since 20 additional Kg of the active ingredient was added to the batch, 20 Kg less of the type 2 item can be added, yielding a batch size of 500 Kg and 50,000 Tablets, each with the correct strength.

Since a compensating item's adjusted weight cannot be known until its type 1 item(s) are weighed, the user of ROPICS weigh are preferably required to weigh up all type 1 items before type 2 items may be weighed.

Usage Code 3: Fixed Weight Item (Using Tare Weight).

Usage code 3 items are fixed weight items which do not vary from batch to batch. An example of a fixed weight item is Sodium Starch Glycolate, which is added to each pre-mix bowl of the batch. Type 3 items are weighed just like type 1 and 2 items (tare weight followed by gross weight), but have no potency and are not adjusted from the required quantity shown in the bill of material.

Usage Code 0: Fixed Weight Item (Using Tare Weight).

Usage code 0 items are just like type 3 items, in that their required quantities are not adjusted from batch to batch. Unlike type 3 items, however, type 0 items do not require check weighing. The most common type 0 item is purified water.

Usage Code Q: Fixed Quantity Item (No Tare Weight).

Usage code Q items are measured in “each” units and, as such, have no tare weight, but just an overall count. An example of these are empty fiber drums that are used for weighing up the other ingredients. Each batch needs a certain quantity of drums, but they are counted, not weighed. Preferably, the system simply requires that the user select the item and scan the lot number. No check or issue is required of the user. The system performs an issue of these items upon confirmation by the user (scan of the lot number). That is, the system issues a database transaction to remove the raw material from inventory.

Usage Code I: Weight of Discharged Blends (Intermediate & Final).

Unlike the usage codes discussed thus far, the “I” usage code does not represent a raw material but, rather, is a placeholder used to capture the weights of blended materials. In a simple example of a batch, the raw materials are weighed. Then all the raw materials are charged to the blender. The ingredients are blended. The mixed ingredients (or granulation) are discharged (removed) from the blender.

This last step introduces a conglomeration of materials that are now mixed together and need to be weighed. Usage code type “I” is used for this purpose. Note that the I type is not an “inventoried” item, but is instead a work-in-process mixture.

If more of a blend is expected to be discharged than will fit into one drum, then the bill of material should have multiple I items, one right after the other, each used to capture the weight of a discharged drum of materials.

Usage Code T: Total of I Type Items.

One or more I type items are followed by a “T” usage code item, which totals up all of the I types. As described above, a granulation bill of material can contain one or more I type items, each of which will be used to capture a drum of discharged, blended material. Following one or more I's will always be a T type item. T items basically are used as a mechanism for the system to sum up all of the drums of a blend (I types) and display their total.

Preferably, the T type item is at the end of each granulation bill of material. In addition to allowing all of the I items to be summed, the T is used by the operator of ROPICS weigh to perform the final receipt of the granulation item number. Once all of the I drums are weighed, the ROPICS Weigh user will select the T item and will be prompted to specify the warehouse and location to use to perform the shop order receipt for the parent item being produced.

Usage code T items may also be found in the middle of a bill of material for granulation items that include a step to discharge an intermediate blend. Such items go through a blending process and then have other ingredients added to the batch and are then blended some more. For items with intermediate blends, the T type item may determine whether adjustments are made to the ingredients that are placed in the “final blend.”

Usage Code S: Adjust for Intermediate Blend Yield.

Some products require that certain ingredients be blended, then discharged from the blender and weighed, then have more ingredients added and be blended some more. The ingredients that are added to the intermediate blend are often referred to as “Extra Granular Excipients.” Of these, some are adjusted so as to remain proportional to the expected intermediate batch size. “S” usage code items behave this way.

In simple terms, S type items are adjusted to account for loss in the intermediate blend process. Consider the following simple example: Assume a standard batch of a product has 99 Kg of ingredients that are initially blended. Assume further that an active ingredient (type 1 usage code) was less than 100% potent, so that an additional 1 Kg of it had to be added to the blend. Accordingly, the weight of materials charged into the blender was 99+1=100 Kg. Now, assume that after blending for awhile, only 90 Kg could be retrieved from the blender (because some of the blend stuck to the mixing blade, hoses, or blending machine, for example). Consequently, the amount of S items added to the intermediate blend before final blending needs to be only 90% of what was planned to be added, so as to be proportional to the overall batch.

To summarize, a total of 100 Kg of ingredients was weighed for the initial blend. After blending for a while, only 90 Kg was retrieved out of blender (lost 10% of batch). Originally going to add 10 Kg of Sodium Starch Glycolate (type S). Now, only add 90% of the 10%, meaning add 9 Kg of the SSG. The technical formula used by ROPICS weigh for this calculation is as follows: S_{q}=Sₒ (A_{T}/(S_{I}−T₁+T_{A}) ), where S_{q}=Amount of usage code S item to add to batch, Sₒ=Original amount of S type item to add (from bill of material), A_{T}=Actual T (summed-up amount of all I types that precede T), S_{I}=Sum of Theoretical I types (from BOM), T₁=Sum of Theoretical 1 types (theoretical amount of active to include), and T_{A}=Sum of Actual ingredients added to batch.

Preferably, the adjustment to S type items is performed if the yield on the intermediate blend falls outside a pre-defined range which is specified on the Item Weigh Parameters of the T type item used to sum the intermediate blend's discharged drums.

Usage Code P: Adjust for Active & for Intermediate Blend Yield.

Like the S code listed above, the P code item's weight is adjusted after the intermediate blend weight is taken. The P usage code item, in fact, goes through the same calculation as the S type, but is first adjusted to compensate for the active adjustment.

Using the example above for the S usage code, an additional 1 Kg of the active ingredient is added to account for sub-potency. So, the first adjustment performed on the P item is to “reverse-adjust” this item's weight by the same amount. So, if 80 Kg of active ingredient is expected to be added, but 81 Kg was required to be added, the S type item could be adjusted down by 1 Kg, followed by taking this result and applying the S type calculation to it.

For example, if 11 Kg of Lactose (type S here) was initially specified to be added to the intermediate blend, and if the original ADS called for 80 Kg, and 81 Kg of the ADS was added, the new Lactose amount could be calculated according to the following formulae. Step 1: NL₁=11 Kg+80 Kg−81 Kg=10 Kg. Step 2: NL₂=NL₁ (A_{T}/(S_{I}−T₁+T_{A}) )=10 Kg (90 Kg/(99−80−81) )=9 Kg Lactose, where NL₁ is the first calculation for lactose to compensate for active adjustment, NL₂ is the final lactose weight calculated, A_{T}=Actual T (summed-up amount of all I types that precede T), S_{I}=Sum of Theoretical I types (from BOM), T₁=Sum of Theoretical 1 types (theoretical amount of active to include), and T_{A}=Sum of Actual ingredients added to batch.

At step 522, the operator selects a component to be weighed. Preferably, as depicted in FIG. 6C, the operator highlights the item to be weighed (e.g., item 9042). If the selected item is selected out of sequence (based on its usage code or operation number), the system provides an out-of-sequence message 620, as shown in FIG. 6D. Preferably, the system also prevents the operator from weighing the selected component until all required prior items have been weighed, and all required prior operations have been completed. In this way, the system prevents an operator from not properly compensating for lot-by-lot variances, such as potency, for example, and from weighing materials in wrong order.

The operator then sets up the scale to be used for the selected item. As shown in FIG. 6E, the operator can provide a scale ID 622 manually or, preferably, by scanning a bar code on the scale. Requiring that the operator scan such a label on the scale removes another layer of possible human error and helps to ensure that the operator will use the proper scale. The system accepts the scale ID and determines whether a scale associated with the scale ID is registered with system (i.e., in the database). The system can then determine, from the database and the item number for the component, whether the scale is of the correct type to be used with the selected item. If the scale is not the correct scale, the system can provide an alert notifying the operator to take corrective action, and prevent the operator from weighing the component until a proper scale is identified. After a proper scale is identified to the system, the operator “zeroes” the scale (usually by pressing a reset button on the scale itself) for each weighing. After the scale is zeroed, the operator can select the “OK” button 625 on the scale zero pop-up 624.

After the scale is zeroed, the system requests the tare weight. As shown in FIG. 6F, the operator provides the tare weight to the system. Preferably, the operator places an empty container on the scale, and the scale provides a weight signal to the system. The weight signal, with the empty container on the scale, represents the tare weight. Alternatively, the operator can read the tare weight from the scale, and manually enter the tare weight into the system via a tare weight data entry field 626.

After taring, the operator provides, at step 524, the lot number of the raw material that is to be used for the selected component. Preferably, to reduce the introduction of human error, the operator scans the bar code from the label affixed to the container in which the raw material is stored. Alternatively, the operator can enter the lot number manually. FIG. 6G depicts a display after the lot number has been entered.

At step 526, the system retrieves from the database status information relating to the lot. The system determines from the status information whether the lot has to be re-tested, for example, or whether the useful life of the lot has expired. If the lot status indicates that the lot has to be re-tested or that the lot has expired, the system provides, at step 528, an indication that the lot status is unacceptable and prevents the operator from continuing with the weighing of that component. Otherwise, the system adjusts the quantity of the ingredient, as described above, to account for the potency of the lot, previous quantities of the item that have already been weighed, and the tare weight of the container.

As described above, to ensure that the total batch size is accurate, the system requires that active ingredients be weighed before compensating ingredients. Accordingly, the weighing process is described in connection with FIG. 5B with reference to a scenario wherein the operator first selects an active ingredient to be weighed, and then selects a compensating ingredient.

At step 532, the system retrieves from the database, the theoretical weight for the selected active ingredient. At step 534, the system retrieves from the database, the lot potency for the lot associated with the lot identifier the operator provides. At step 536, the system calculates and displays the desired weight, as described above, for the active component. As shown in FIG. 6G, the lot potency 628 and desired gross weight 629 can be displayed. The desired gross weight is the desired net weight of the raw material plus the tare weight of the container.

The operator can then begin to add raw material to the container on the scale. At step 538, the system receives weight signals from the scale. The weight signals represent the actual combined weight of the container and the raw material added thereto. As shown in FIG. 6H, as weight is added to the receiving container, the system displays a relationship between the actual component weight and the desired component weight. As shown in FIG. 6H, the system can display a bar 630, which indicates whether the actual weight 632 is less than, equal to, or greater than the desired weight 629.

If, at step 540, the system determines that the actual weight 632 equals the desired weight 629, the system provides a target weight achieved indicator. Preferably, the system provides the target weight achieved indicator by displaying the bar 630 in green. The system can require that the actual weight 632 be “equal” to the desired weight 629 to within any tolerances that are acceptable for the product being manufactured. In a drug application, for example, very little tolerance will likely be allowed. In such an application, the system can be made to require that the actual weight 632 be equal to the desired weight 629 to within the precision of the scale. Alternatively, the tolerance can be set so that the actual weight 632 is within a certain percentage of the desired weight 629.

If, at step 542, the system determines that the actual weight 632 is greater than the desired weight 629, the system provides an overweight indicator at step 544. Preferably, the system provides the overweight indicator by displaying the bar 630 in red. The operator can eliminate the overweight problem by removing raw material from the scale until the bar 630 turns green.

If, at step 542, the system determines that the actual weight 632 is less than the desired weight 629, the system provides an underweight indicator at step 546. Preferably, the system provides the underweight indicator by displaying the bar 630 in yellow. The operator can eliminate the underweight problem by adding raw material to the scale until the bar 630 turns green.

The system continues to track the actual weight of the component at step 550, unless an end-of-lot indicator is received at step 548. If the operator uses all the raw material in the lot, but has not yet reached the desired weight for the component, the operator can provide an end of lot indicator to the system. If an end of lot indictor is received, the system requests the lot ID for a second lot of the same raw material. At step 552, the operator provides the second lot ID by scanning the bar code label affixed to the container that contains the second lot.

At step 554, the system checks the current lot status, as described above, and, if the current lot status is unacceptable, the system provides an unacceptable lot indicator at step 556. If, at step 554, the system determines that the lot is acceptable for use, the system, at step 558, calculates an adjusted weight based on the potency of the second lot, and the amount of material already weighed from the first lot. The system provides the second adjusted weight to the operator, and, at step 560, resumes tracking the actual weight until the actual weight of material from the second lot is equal to the desired weight.

At step 562, the system accepts the component as weighed. Preferably, the system requests that the weigher provide his user ID and password to approve the weighing of the component. FIG. 61 depicts a display 634 for requesting the user ID and password from the operator (i.e., the authorized person that logged in to the system). Preferably, the system is configured so that this verification feature can be turned on or off by item. The user can enter the user ID and password manually, or can scan in the user ID and password using an encrypted token as described above. Optionally, the system can require a second approval from a second authorized user before accepting the component as weighed.

After the component is accepted, the system causes a weigh label to be printed for application to the receiving container. Preferably, the weigh label identifies the shop order the weighed component is to be used to fill, the item number and lot number associated with the weighed component, the net quantity of weighed material, and the charging sequence ID that identifies the point in the charging sequence for the product that the weighed component is to be charged to the blender.

After the component has been accepted, the database can be updated to reflect that the weighed amount is no longer available but, rather, is in a weighed state. That is, the system can update the back-end database to decrease the amount of that lot that is available by the amount that has been weighed, and create a new entry for that lot indicating that that amount has been weighed. Alternatively, the system can treat all the weighed material as available until it is charged.

After the active ingredients have been weighed, the operator can select a compensating ingredient for weighing. At step 564, the system retrieves the theoretical weight for the compensating ingredient. After the operator scans the lot ID for the lot of raw material to be used, the system performs checks on the lot as described above. At step 566, the system calculates the desired weight for the compensating ingredient as described above, and displays the desired weight to the operator.

The operator adds raw material to the scale until the weight indicator indicates that the actual weight equals the desired weight. If, at step 568, the system determines that the actual weight does not equal the desired weight, then, at step 570, the system continues to track the actual weight until the actual weight equals the desired weight. If, at step 570, the system determines that the actual weight equals the desired weight, then, at step 572, the system accepts the component. That is, the system allows the operator to print the weigh label for the weighed-up component. FIG. 6J depicts a display 636 via which an operator can request the printing of a weigh label for a weighed-up component. At step 574, the operator continues through the list of components until all components have been properly weighed.

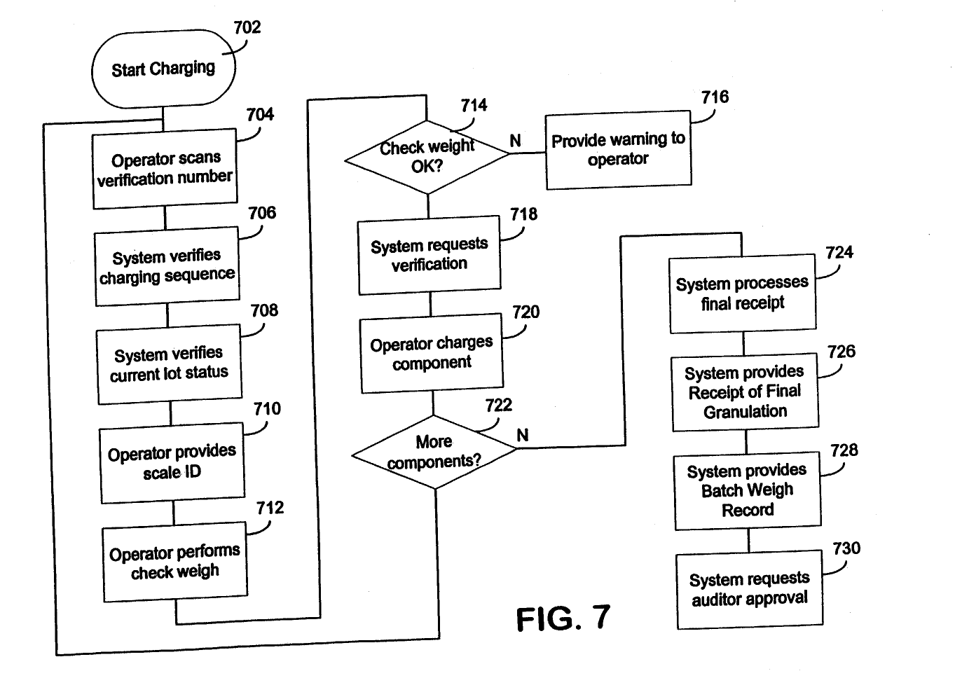

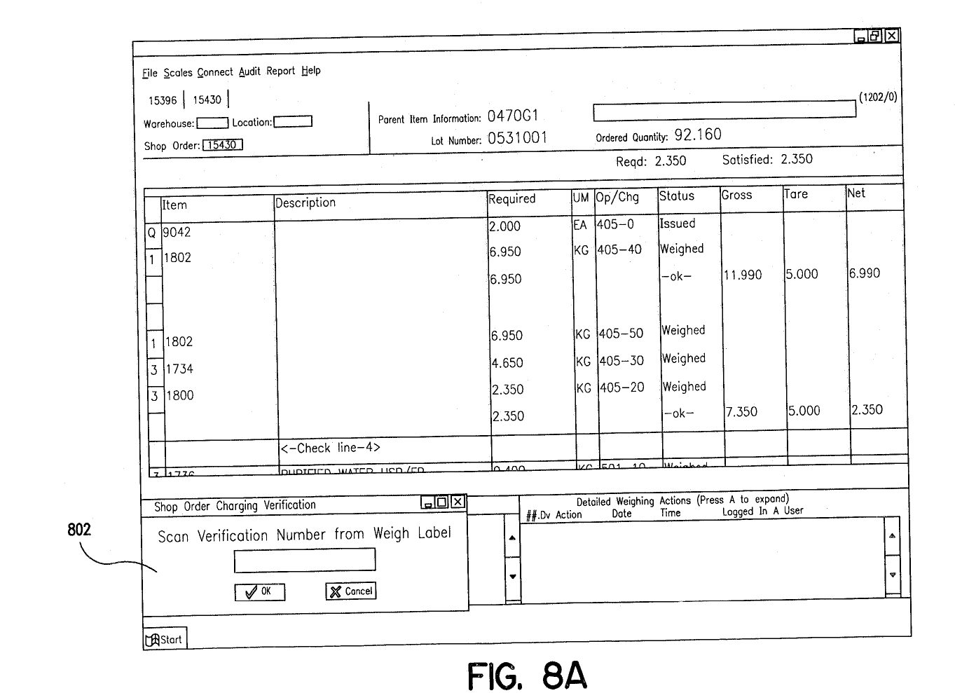

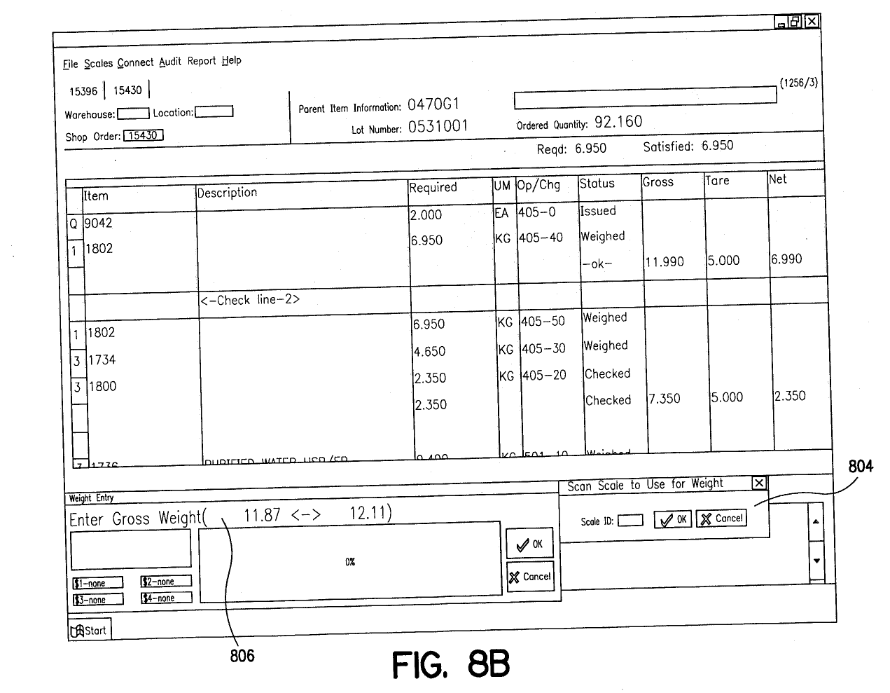

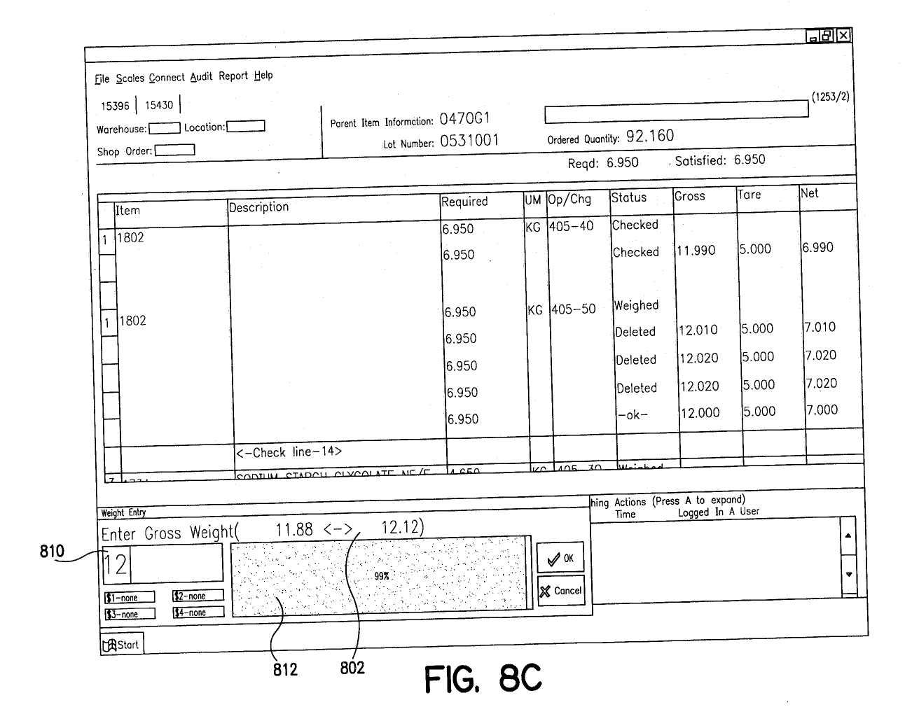

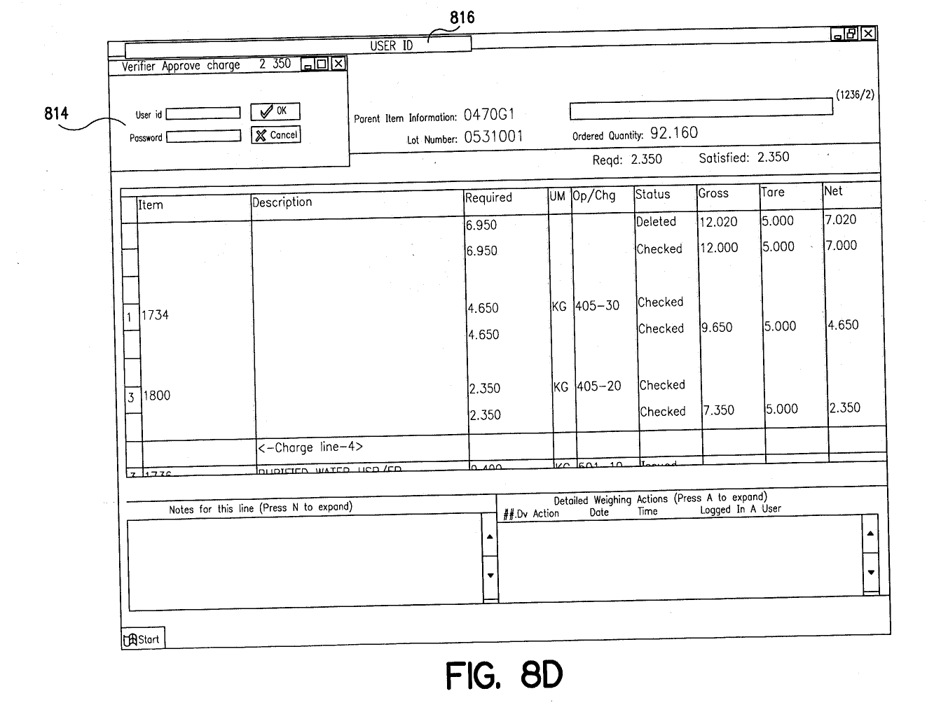

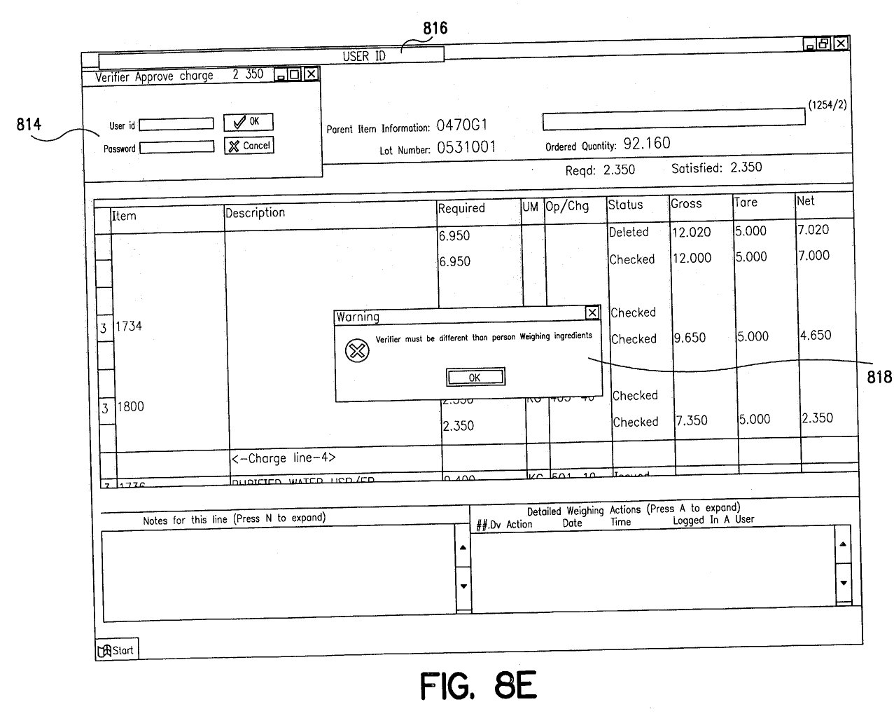

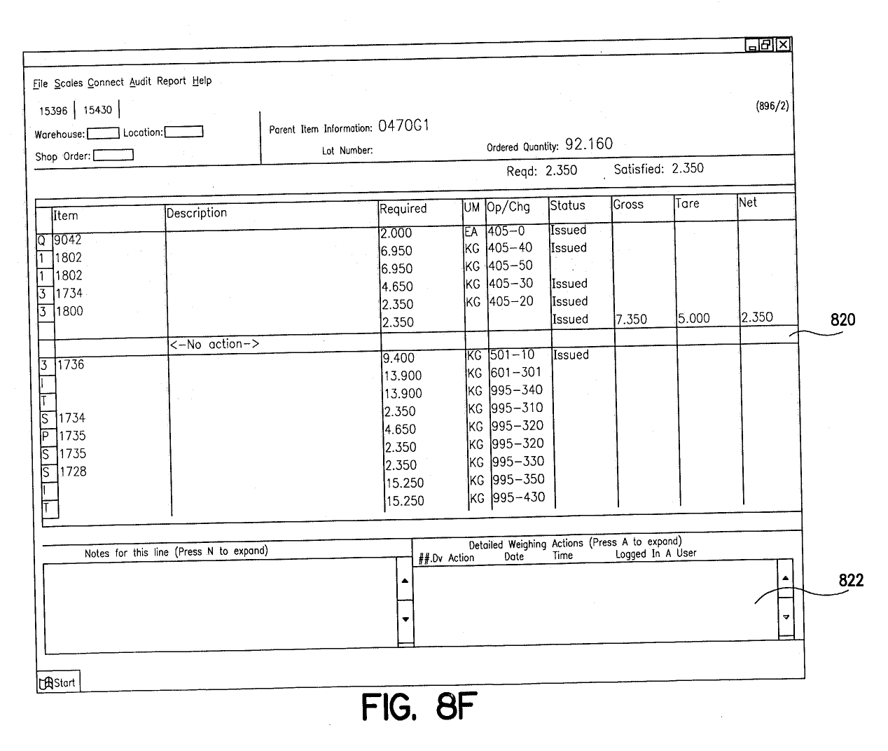

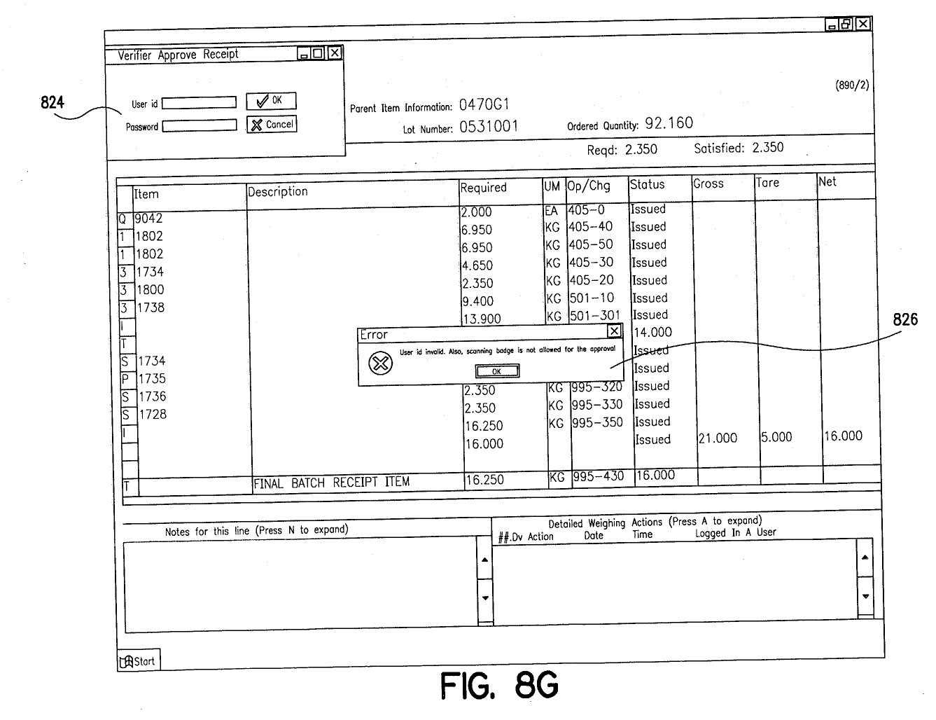

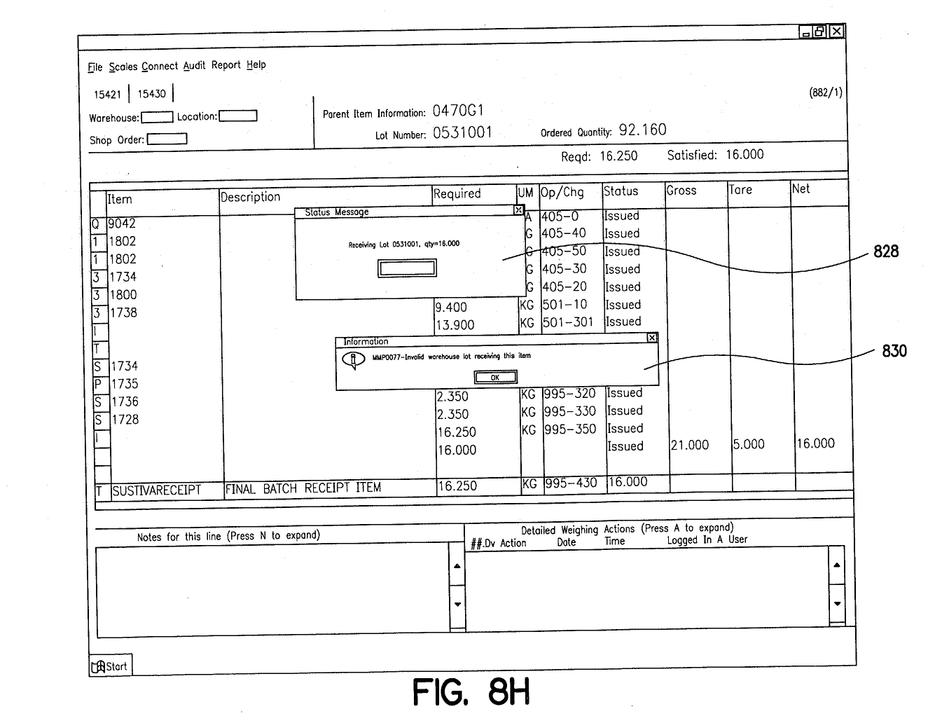

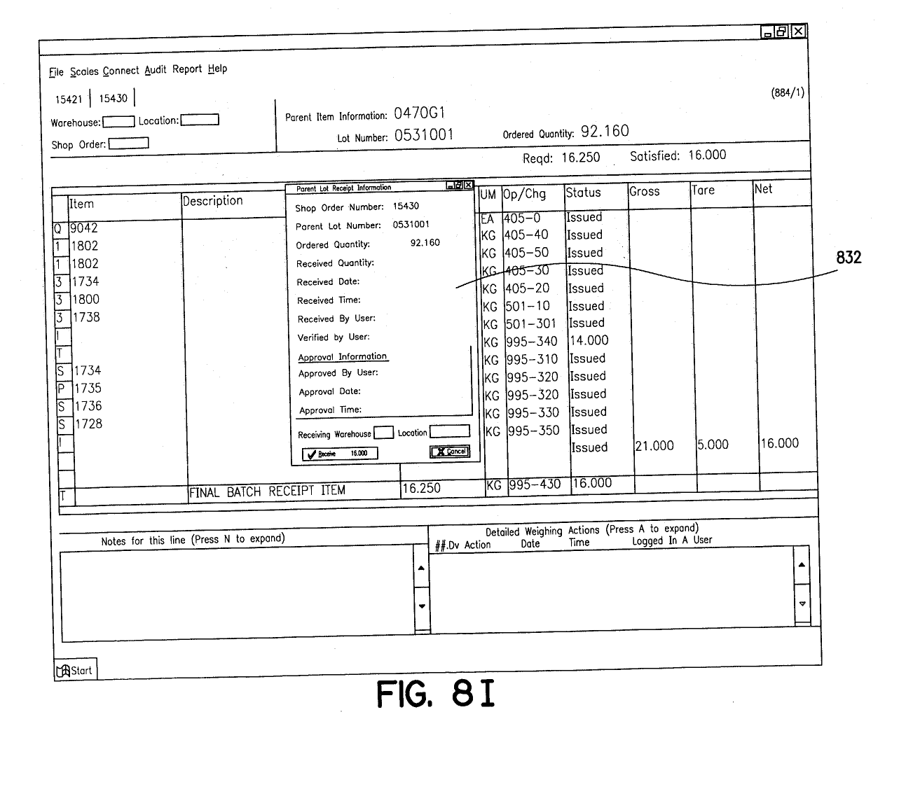

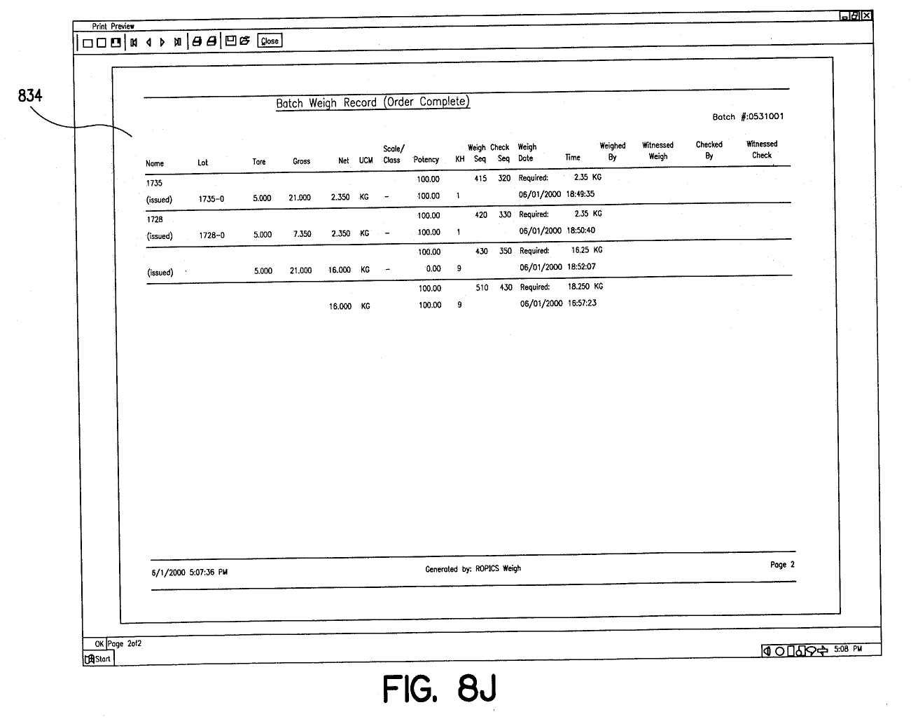

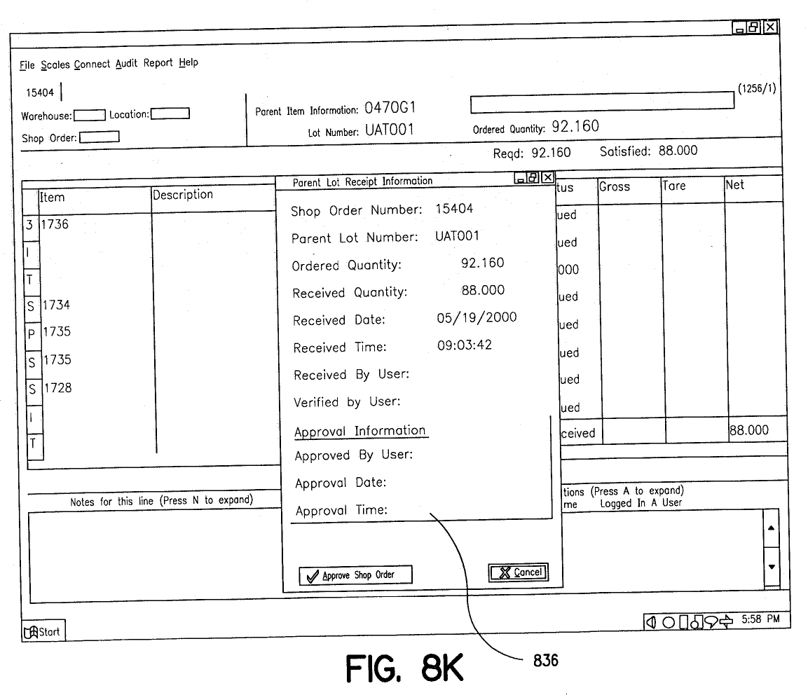

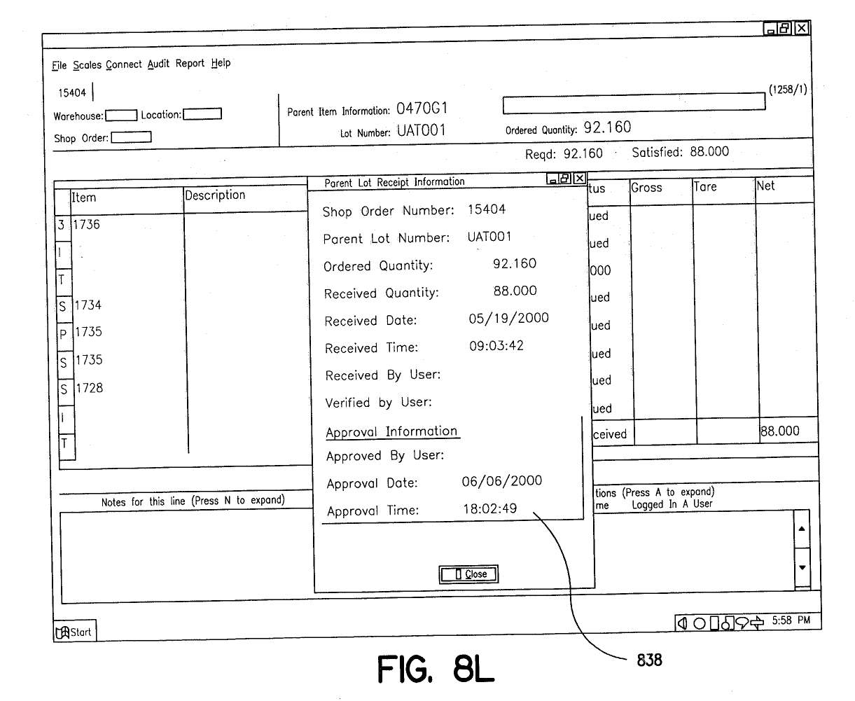

After all components have been properly weighed, the operator can then proceed to charging and blending the components to form the product (or intermediate). Systems and methods according to the invention for charging components of a product using a ROPICS will now be described in connection with FIGS. 7 and 8. FIG. 7 is a flowchart of a preferred embodiment of a method 700 according to the invention for charging components of a product using a ROPICS. FIGS. 8A-8L depict a preferred embodiment of a user interface for charging components of a product using a ROPICS according to the invention.

At step 702, the operator initiates the ROPICS Weigh Charge-in process. Preferably, to reduce the likelihood of human error, the system requires, at step 704, that the operator scan the verification number from the weigh label for the first component to be added to the blender. Similarly, a preferred embodiment of the system disallows manual entry of all item, lot, quantity, and scale identification. Alternatively, the operator can provide the verification number manually. FIG. 8A depicts a display 802 for providing the verification number.

Preferably, the system requires that the components be added to the blender in a specific order. As described above, each component (i.e., weigh line) has an associated charging sequence number. The system requires that the components be added to the blender in order of their respective charging sequence numbers. Accordingly, the system accepts the verification number for the first component, and, at step 706, the system determines whether all previous components have already been added to the blender. If a component is selected out-of-sequence, the system provides an alert to the operator indicating that the selected component cannot be properly added until all preceding components have been added. Thus, the system reduces the possibility that a component will be added out of sequence.

Additionally, at step 708, the system verifies the current status of the lot, in case the status of the lot has changed since the component was weighed. If the current lot status has changed such that the weighed-up component cannot be used in the batch, the system provides a lot status alert to the operator, and prevents the operator from continuing with the charging process.

After the operator selects a component for charge-in, the operator provides a scale ID to the system at step 710. Preferably, to reduce the likelihood of human error, the system requires that the operator provide the scale ID by scanning a symbol code on a label affixed to the scale. Alternatively, however, the system can permit the operator to provide the scale ID manually. FIG. 8B depicts a display 804 for providing the scale ID.

The system accepts the scale ID and determines whether a scale associated with the scale ID is registered with system (i.e., in the database). The system can then determine, from the database and the item number for the component, whether the scale is of the correct type to be used with the selected component. If the scale is not the correct scale, the system can provide an alert notifying the operator to take corrective action, and prevent the operator from weighing the component until the proper scale is identified. After the proper scale is identified to the system, the operator “zeroes” the scale (usually by pressing a reset button on the scale itself) for each weighing.

At step 712, the system requires the operator to perform a “check weighing” of the component before the component can be added to the blender. Preferably, the system requires that the actual weight of the previously weighed component be within an allowable tolerance of the expected weight. The tolerance can be set from zero to as wide as the system is willing to tolerate for the product being manufactured. The check weighing process ensures that no significant changes were made to the quantity of the component since it was weighed. As shown in FIG. 8B, a preferred embodiment of the system requires that the check weight be within 1% of the expected weight (11.99±0.12). The system can display the desired weight range 806 as shown.

Preferably, to perform a check weighing, the operator places the weighed up component on the approved scale, and the scale provides a weight signal to the ROPICS Weigh PC. Alternatively, the operator can enter the check weight manually. As shown in FIG. 8C, the system can display a representation of the actual weight 810 of the component. Preferably, the system displays a representation of the relationship between the actual weight and the desired range. For example, the bar 812 shown in FIG. 8C can be displayed in green as long as the actual weight 810 is within the desired weight range 808. Similarly, the bar 812 can be displayed in red if the check weight 810 is over the desired range 806; yellow if under. If, at step 714, the system determines that the actual weight of the component is out of tolerance, the system provides a warning to the operator at step 716, and requires the operator to contact a supervisor and re-weigh the component from scratch. Alternatively, the system could allow the operator to adjust the weight until it is in range, though this approach should be discouraged because a change in weight typically indicates that something worthy of investigation occurred.

As an additional check on the quantity of the component, the system, at step 718, requires that a weight checker verify the check weight prior to charge-in. The checker verifies the check weight by providing the checker's user ID and password. FIG. 8D depicts a display 814 for providing the checker's user ID and password. The checker can use an encryption token in most cases, but must manually enter his password during the first token use of each session.

Preferably, the system requires that the checker be an authorized user of the system (as determined from the database), and be someone other than the authorized user 816 who logged into the system initially. If the system detects that the checker and user are not different, authorized users, the system will provide an alert to the operator, and prevent the operator from continuing the charging process until a separate, authorized user verifies the check weight of the component. FIG. 8E depicts an alert 818 that can be provided if the system detects that the weigher 816 and checker 814 are not different users.

At step 720, the weigher charges the component into the blender. After the component has been charged, the system prevents any further action from taking place with respect to that weigh line. As shown in FIG. 8F, the system can display a “no action” indicator 820 to indicate to the operator that no further action can be taken against that line. Also, as shown in FIG. 8F, the system can display a record or audit trail 822 of all actions taken with respect to each line item. Preferably, the system stores the audit trail in the database for later retrieval, if necessary.

The operator continues the charging process until all components have been charged to the blender. After the system determines at step 724 that all components have been charged, the weigher assigns a final receipt amount from the scale. That is, the operator provides the system with an indication (such as by providing the operator's user ID and password) that indicates that the operator agrees that the total amount of product shown at the bottom of the shop order is the correct amount (within tolerance) of everything that has been weighed. Preferably, this process requires that a checker verify the total weight. The checker must be an authorized user of the system, and someone other than the weigher. FIG. 8G depicts a display 824 whereby the checker can enter his user ID and password. FIG. 8G also depicts a pop-up alert 826 that can be displayed if the system determines that the checker is not a different user from the weigher, or if the system determines that the would-be checker is attempting to scan his badge rather than entering the user ID and password manually.

The system then processes the final receipt. That is, the system receives the new lot into inventory by updating the database to reflect that the raw materials are no longer available (or in a weight state), but are now blended. FIG. 8H depicts a display 828 that shows processing of the final receipt. As shown, the display 828 provides a notice to the operator containing the new lot number for the blend, and the quantity of the blend that has been made. The database is updated to show that that quantity of the blend is now available at the warehouse and location specified.

Also, as shown in FIG. 8H, the system can check to be sure that the blend can be stored in the warehouse and location specified. For example, in some applications the warehouse is a logical designation, rather than a physical designation. That is, the warehouse might represent a “quarantine” warehouse wherein items that cannot be used are “stored.” This logical designation enables the system to keep track of what items can or cannot be used, regardless of where they are physically stored. If the system determines from information in the data store that the item cannot be stored in the warehouse or location provided, the system provides an alert 830 as shown in FIG. 8H.

At step 726, the system provides a Receipt of Final Granulation. FIG. 8I depicts a display 832 for providing a receipt of final granulation. The receipt of final granulation includes a receiving summary that includes the received quantity, date, time, user, and verifier that participated in the charging process. The operator scans in the receiving warehouse and location from bar code labels affixed to the walls of the location.

At step 728, the system provides a Batch Weigh Record to the operator for review and approval. The batch weigh record is basically an audit report of everything that went into the batch. FIG. 8J depicts a display of (a second page of) a batch weigh record 834.

At step 730, the system requests audit approval of the final granulation. FIG. 8K depicts a display for providing audit approval. Preferably, the system requires an auditor, such as a quality assurance (QA) auditor to review and approve the on-line audit report. To approve the audit report, the auditor highlights the final receipt line. The system responds by providing an approval box or pop-up. The auditor checks on Approve Shop Order button 836 (using the PC's mouse for example) to approve the on-line audit report. FIG. 8L depicts a display after the auditor has approved the audit report. Note that the pop-up 838 now includes an auditor ID.

The ROPICS Weigh, and ROPICS in general, is designed to provide optional features and other settings that allow the system to be fine-tuned to the site or user's preferences. The most common form of parameter is found in the ROPICS Parameters File (RPZPA). Various programs read the parameters found in this file and, depending on the values found, will behave differently. In some cases, entire sets of functions can be “turned off” if a site does not wish to use them, while in others the parameters have numeric values that are more for tweaking of performance.

To modify the ROPICS parameters, one can simply access the ROPICS menu (by typing “ROP” in the BPCS menu field, for example) and then choose option 21. Selecting this option will then present an 8-character field where the “key” to the parameter may be entered or where F4 may be pressed to browse through the available parameters.

For simple interactive display programs, the program generally reads all of the relevant parameters upon start-up and will maintain these parameters during that particular execution of the program. Other programs run “perpetually”, meaning that they run in the background for days at a time. These programs, which include ROP600, ROP610, ROPSOCK, ROP620, and CIM600, also read their parameters upon invocation, so simply changing a parameter while these programs are running will not result in the change being picked up right away. To make it easier to make parameter changes to such programs, there is a special parameter called “GETPARMS”. The programs ROP600 and ROP610, when GETPARMS is set to Y during their execution, will re-read all of their parameters and begin using the new values. ROPSOCK will re-read only the list of IP-to-Device mapping records and add any new ones to its list, allowing a new device to be set up without re-starting ROPICS, but not allowing a change to a current device mapping during ROPSOCK execution. CIM600 and ROP620 only read parameters upon startup.

ROPICS parameter FQTYSCOK applies to the Shop Order Readiness check, which ensures that shop orders match their bills of material before allowing execution. If this parameter is set to Y (yes), then quantities on finished goods shop orders (packaging orders) are allowed to vary by up to the scrap quantity amount without causing the readiness check to fail.

ROPICS parameter HH-RWAYT contains timing parameters that affect the ROPICS Weigh PC. The parameter is formatted as follows: aaaaabbbbbccc, where aaaaa is the maximum time (in seconds) that is allowed between weighing up a line item and finishing the line. This ensures that not too much time elapses between the time a line item is begun and the ingredients are used in the batch. bbbbb is the maximum time (in minutes) between checking a line and charging it. If this amount of time is exceeded, the system will force the user to re-check the line item's weight. ccc is the scale tolerance used for check weighing. This number, multiplied by the scale graduation, will provide the tolerance allowed between the weighed up amount and the checked amount. For instance, a value of 006 in this parameter, using a B class scale (graduation=0.01) will result in a tolerance of 006×0.01, or 0.06. So, the check weight can vary either up or down by this amount from the original weight.

For greater assurance that the order about to be processed using the ROPICS Weigh is correct and matches the current version of the bill of material, ROPICS parameter RWAYCKRD is set to Y. If this is done, then no order which does NOT match the bill of material (readiness ok) will be allowed to be used by the ROPICS Weigh.

Along with the RWAYCKRD (check order for readiness), shown above, ROPICS parameter RWAYLKOR, if set to Y, will cause the order to be locked once it is downloaded to the ROPICS Weigh. Locking an order prevents changes to its bill of material information.

ROPICS parameter MINRWAYV defines the minimum version of ROPICS Weigh that will be allowed to access orders from the server. Upon logging on to the host system from ROPICS Weigh, this minimum version number is downloaded to the PC system, which then compares its internal version number to that of MINRWAYV. If its number is less than the minimum, then the log on cannot proceed and the PC system will need to be upgraded before it is used again.

When the File/Upgrade option is chosen from the ROPICS Weigh, the system will use the path shown in ROPICS parameter HH-UPRWP to find the latest program and settings files to use for the upgrade. This parameter is downloaded when the user first attempts to log on to the server using the ROPICS Weigh. For the upgrade function to work, an attempt must first be made to access the host so that the path for the upgrade may be found.

This parameter should be in PC DOS Path format. For instance, specifying C:\ in this parameter would cause ROPICS Weigh to upgrade using files found on the C: drive of the local computer. A preferred value to give this parameter is a path name for a network drive to which all ROPICS Weigh PC's have access. This may be something like P:\GLOBAL\RWAY, which will look on the networked P: drive for the upgrade files, but an even more flexible approach is to specify the full network attachment identifier, such as \\DMFILESERV\FILES\GROUP\BARCODE\RWAY which will work regardless of the drive letter mapping (e.g., “P:”) that is assigned. When upgrade is chosen, ROPICS Weigh looks in the specified path for a file whose name is RWAY.LST, which should be a plain text file with a list of the files to be upgraded.

ROPICS parameter HH-RWKEY is used to turn off all keystrokes in ROPICS Weigh where bar code scanning or direct reading from the scales should be performed. For general testing, it is often useful to leave this parameter as N, but for production use this should be set to Y, which will make sure that fields that should be scanned or automatically picked up by the system are not simply keyed in by the user on the keyboard.

Setting ROPICS Parameter ROPWEIGH to Y indicates to the system that the ROPICS Weigh is being used at this site. The effect of this parameter is to cause the item master program to display a fourth screen of inputs which relate directly to weighing parameters for the item (see RPIWP below).

Several settings for the ROPICS Weigh apply to the weighing of a particular item, versus applying to the system as a whole. Most of ROPICS's Item Weigh Parameters, RPIWP, can be found on screen 4 of the item master maintenance program (INV100). If the ROPWEIGH parameter (see prior section) is set to Y, then during item master maintenance an additional screen of information pertaining to ROPICS Weigh for this item will be displayed. These settings are transmitted to the ROPICS Weigh PC for each parent and component item on the shop order, so if a change is made to one of these settings, re-accessing the shop order will pick up the new parameter.

ROPICS parameter RPIWP, “Use With ROPICS Weigh?,” tells the system whether this item (as a parent item) should be allowed to be weighed up using the ROPICS Weigh system. If the value is N, none of the other fields will be displayed. Setting the value to Y will display all of the other fields and allow them to be edited. Note that a value of N in the “Use with ROPICS Weigh?” parameter will disallow a shop order for this parent item to be downloaded to the ROPICS Weigh PC.

For all raw materials that are ingredients of granulation items that will be weighed with ROPICS Weigh, this field can be set either to Y or to G. The G (global) setting will allow the item to be used by ROPICS Weigh, but all of its detailed settings will default to those on the special system item, ‘*GLOBAL’. For common items that share all of the same values for these parameters, ease of entry is facilitated by setting up a common *GLOBAL item and then pointing the common ingredients to it by placing a G in this field.

The Measurement Ranges Allowed parameters (RPIWP) deal with tolerances on check weights and yields. The first, “Gross Weight Check % Range” specifies the lower and upper percentage range (of the initial weighed amount) that must be achieved to pass the check weight step. The second range, “Extra Granular Adjustment % Range” specifies how far out of tolerance an intermediate blend must be before the extra-granular excipients must be adjusted. Note that this second range parameter applies only to the T type items. If the total T collected (sum of the “I” bowls) varies by greater than either the lower or upper yield % from the bill of material quantity for this T item, then S and P type items will have their blend yield calculations performed (note: The P type will always get its “adjust for active ingredient” adjustment made, regardless of this range).

The Verifications Required settings, RPIWP, include four entries that tell the ROPICS Weigh which steps during the weighing and charge in process should require users to verify their action by identifying themselves with their user id and password. These can be made as lenient or strict as desired, from no verifications required, to a user id and password having to be input for every step along the way.

The steps where this can be specified include: the initial taking of the tare weight, taking the gross weight, check weighing the drum, and charging the drum into the blender. For each of these steps, specify one of the following:

N=No approvals are required of either user.

W=Weigher must approve. With this setting, the user currently signed on to the ROPICS Weigh PC will be the one who must verify the action. This user is referred to as the weigher, even if the step in question is, say, charging.

V=Verifier must approve. With this setting value, the step in question will require a person other than the signed-on user (a “verifier” or “witnesser”) to key in their identification as a way of saying that they witnessed the step and agree that it was done according to the correct procedures, etc.

B=Both. With this setting, both the signed on user and the Verifier must key in their user id and passwords in order to proceed with the step in question.

Each item needs a scale class (ROPICS parameter RPIWP) specified for both its weighing step and for its check-weighing step. These classes determine which scales may be used in the weighing and checking functions. The rule that ROPICS Weigh uses for an item is that the initial weight taken (first lot) for a line item (BOM line) must use a scale that has a graduation (i.e., precision) greater than or exceeding the specified scale in precision.

For instance, if an item's weigh scale class is specified as a “B” class (scales that can weigh up to a precision of 0.01 units), then the graduation of the scale used must be less than or equal 0.01. A scale class of D (0.005) or G (0.002), for instance may be used for this weight.

However, once the initial weight is taken for a line item, all subsequent weights for this item must use the exact same scale class as the scale originally used. So, if the first weight was taken on a D scale (0.005), but only a B class was specified, all subsequent weights to satisfy this line must then be performed on a D class scale. Note: The scale id scanned during weighing will identify a scale from the scale master (RPSCA) in ROPICS on the server. The scale master entry tells ROPICS Weigh the class of the scale.

RWAY Scale Class Specifications

| Scale Class | Graduation |
|---|---|
| A | 0.001 |
| B | 00.01 |
| C | 000.1 |
| D | 0.005 |
| E | 000.2 |
| F | 00.02 |
| G | 0.002 |
| H | 000.5 |
| I | 00.05 |
| J | 1.000 |

Because BPCS, for example, requires quantities that are calculated to three decimal places, the ROPICS weigh manipulates these numbers, before requesting that weights be taken, using the following steps:

1. First, the number is rounded up/down to the number of decimals of precision supported by the scale. For instance, if a class B (or F or I) scale is being used, and the original quantity required is 3.251, the quantity expected to be weighed will be rounded to 3.25. Rounding up will be done for numbers 5 and up (for example, 3.415 would become 3.42).

2. If necessary, the least significant digit is corrected to allow it to be read by the scale class. The current number (after step one is performed) will have the correct number of decimals, but may not be measurable with the scale class being used. For example, if the scale class is F (0.02 graduation) and the required quantity is 298.43, there is no way to get this number to display on the scale indicator—it will jump from 298.42 to 298.44. So, the least significant digit will be changed as follows:

| Original # | Grad ends in 1 | Grad ends in 2 | Grad ends in 5 |
|---|---|---|---|
| ends in 0 | no change | no change | no change |
| ends in 1 | no change | change to 0 | change to 0 |
| ends in 2 | no change | no change | change to 0 |
| ends in 3 | no change | change to 2 | change to 5 |
| ends in 4 | no change | no change | change to 5 |
| ends in 5 | no change | change to 6 | no change |
| ends in 6 | no change | no change | change to 5 |
| ends in 7 | no change | change to 8 | change to 5 |
| ends in 8 | no change | no change | change to 10 |
| ends in 9 | no change | change to 10 | change to 10 |

Examples:

| Grad | Original | New Number |
|---|---|---|
| .02 | 3.43 | 3.42 |
| .02 | 3.29 | 3.30 |
| .005 | 4.234 | 4.235 |
| .005 | 4.231 | 4.230 |
| .005 | 4.238 | 4.240 |

As shown, any graduation ending in a 1 can be achieved exactly (except for initial rounding for precision). For a graduation ending in a 2, exact quantities can be achieved 50% of the time; the desired weight will be exceeded 20% of the time, and the actual weight will be less than the desired weight 30% of the time. For graduations ending in 5, exact quantities can be achieved 20% of the time, the desired weight will be exceeded 40% of the time, and the actual weight will be less than the desired weight 40% of the time.

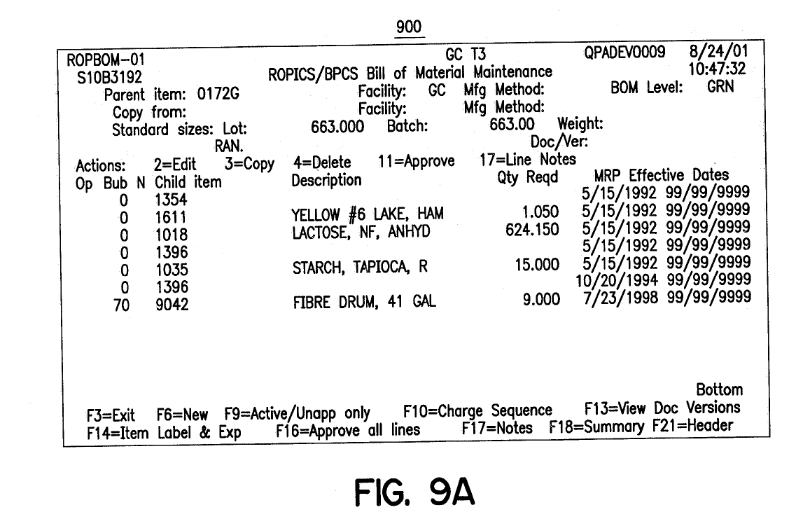

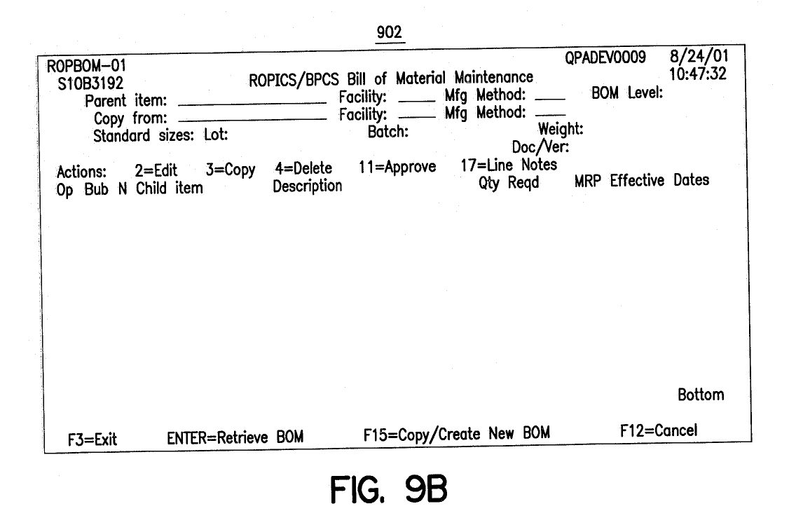

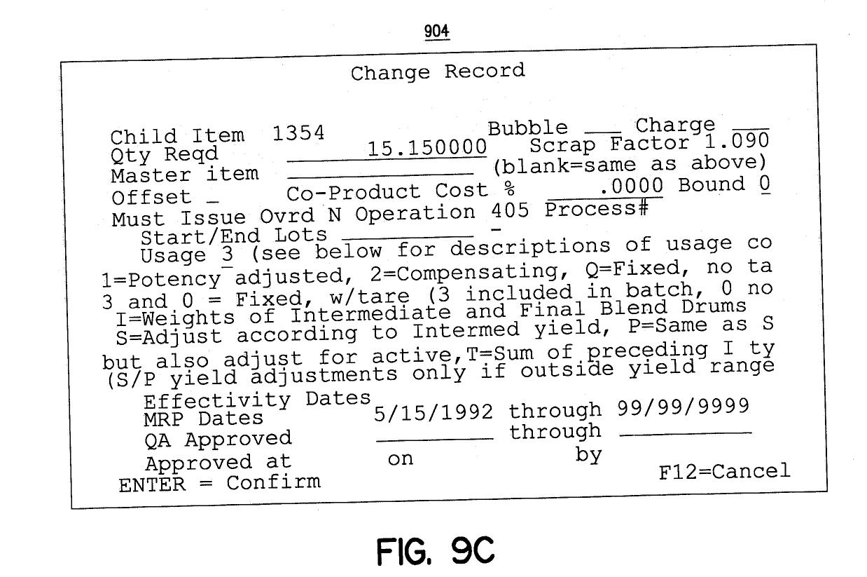

A key to automating the manufacturing process is ensuring that all of the information on ingredients going into a batch is correct and current. As part of the ROPICS Weigh implementation, the BPCS Bill of Material editing program, BOM500, was replaced with a more user-friendly and feature-rich system to maintain bills. The main program in this system is called ROPBOM, and a preferred embodiment of a user interface for the ROPBOM will now be described in connection with FIGS. 9A-9C.

As shown in FIG. 9A, the initial screen 900 allows the entry of the item number, facility, and method for maintenance purposes (similar to the initial screen of BOM500). As shown in FIG. 9B, the main edit screen 902 displays all of the “child” items used on the bill. The default sort sequence is by bubble number (Bub), and indicates the sequence of weighing for the raw materials. BPCS, for example, uses bubble number in conjunction with its Bills of Material. As shown in FIG. 9C, the details edit screen 904 allows for the maintenance of specific attributes of this item's usage on this bill of material.

Thus, there have been described systems and methods for weighing and charging components of a product using a radio-frequency order picking and inventory control system. Those skilled in the art will appreciate that numerous changes and modifications can be made to the preferred embodiments of the invention, and that such changes and modifications can be made without departing from the spirit of the invention. It is intended, therefore, that the appended claims cover all such equivalent variations as fall within the true spirit and scope of the invention.

What is claimed is:

1. A method for weighing components of a product, the method comprising:
receiving a shop order identifier associated with the product;
retrieving from a data store, shop order data associated with the shop order identifier;
comparing the shop order data to a current bill of materials associated with the product to determine whether the shop order data is consistent with the current bill of materials; and
if the shop order data is not consistent with the current bill of materials, providing a shop order mismatch indicator.

2. The method of claim 1, further comprising:
if the shop order data is consistent with the current bill of materials, displaying a list of components associated with the shop order identifier.

3. The method of claim 1, further comprising:
locking the shop order only if the shop order data is consistent with the current bill of materials.

4. The method of claim 3, wherein locking the shop order comprises disapproving of an attempt by an operator to weigh a component that is not associated with the shop order identifier.

5. The method of claim 1, wherein retrieving the shop order data comprises retrieving the shop order data from an enterprise requirements planning (ERP) system database.

6. The method of claim 5, further comprising:
storing, in the ERP database, current data associated with the current bill of materials and the shop order identifier.

7. The method of claim 1, wherein comparing the shop order data to the current bill of materials comprises comparing the shop order data to a bill of materials that was updated after a shop order associated with the shop order identifier was cut.

8. The method of claim 7, further comprising:
updating the bill of materials after the shop order is cut and before the shop order identifier is received.

9. A system for weighing components of a product, the system comprising:
a server computer having a back-end database for storing inventory data;
a client computer that is communicatively coupled to the server computer via a communications network; and
a scale for providing to the client computer a weight signal that represents an actual weight of a component on the scale,
wherein the server computer includes a data queue for receiving and managing database transaction requests in real-time, and a transaction server for receiving the database transaction requests from the data queue and for interfacing with the back-end database to process the received database transaction requests in real-time.

10. The system of claim 9, wherein the client computer comprises a symbol code reader for scanning and interpreting symbol codes.

11. The system of claim 9, wherein the back-end database is an enterprise requirements planning (ERP) system database.

12. The system of claim 9, wherein the transaction server communicates in real-time with a database transaction server associated with back-end database.

13. A method for weighing components of a product, the method comprising:
receiving a location identifier associated with a manufacturing location;
receiving a shop order identifier associated with the product;
retrieving from a data store, shop order data associated with the shop order identifier, the shop order data including a list of components that are required to make the product;
determining from the shop order data whether the components that are required to make the product are currently available in sufficient quantity at the location; and
if the components that are required to make the product are not currently available in sufficient quantity at the location, providing an insufficient quantity indicator.

14. A method for weighing components of a product, the method comprising:
receiving a shop order identifier associated with the product;
retrieving from a data store, shop order data associated with the shop order identifier, the shop order data including a list of components that are required to make the product;
receiving a lot identifier that corresponds to a first lot of a first component in the component list;
determining a current status of the first lot of the first component; and
based on the current status of the first lot of the first component, providing an indicator as to whether the first lot of the first component should be used to manufacture the product.

15. The method of claim 14, further comprising:
if the current status of the first lot of the first component indicates that the first lot of the first component should not be used, disapproving an attempt by an operator to weigh a subsequent component associated with the shop order identifier until a subsequent lot of the first component having an acceptable current status is weighed.

16. The method of claim 14, wherein the current status indicates whether a useful lifetime for the lot has expired as of the time the lot identifier is received.

17. The method of claim 14, wherein the current status indicates whether a re-testing period associated with the lot has expired as of the time the lot identifier is received.

18. The method of claim 14, further comprising:
receiving a location identifier associated with a manufacturing location; and
wherein the current status indicates whether a sufficient quantity of the first lot of the first component is currently available at the manufacturing location.

19. A method for weighing components of a product, the method comprising:
retrieving a theoretical weight for a first component in the component list;
receiving a lot identifier that corresponds to a first lot of the component;
determining a potency for the first lot;
calculating a desired weight for the first component based on the theoretical weight and the potency for the first lot; and
providing a representation of the desired weight to an operator.

20. The method of claim 19, further comprising:
receiving an actual weight for the first component;
retrieving a theoretical weight for a second component in the component list; and
calculating a desired weight for the second component based on the actual weight for the first component and the theoretical weight for a second component.

21. The method of claim 19, further comprising:
receiving an actual weight for the first component;
calculating an adjusted theoretical weight for the first component based on the actual weight of the first component and the potency of the first component;
receiving a second lot identifier that corresponds to a second lot of the component;
determining a potency for the second lot;
calculating an adjusted desired weight for the first component based on the adjusted theoretical weight for the first component and the potency for the second lot; and
providing a representation of the adjusted desired weight to an operator.

22. A method for weighing components of a product, the method comprising:
receiving a shop order identifier;
retrieving from a data store, shop order data associated with the shop order identifier, the shop order data including a list of components that are required to make the product;
providing a display that includes a visual representation of a first component from the list of components and a desired weight associated with the first component;
receiving a representation of an actual weight associated with the first component;
accepting the first component if the actual weight associated with the first component is within a predefined tolerance of the desired weight associated with the first component; and
updating an inventory data store associated with the lot identifier based on the actual weight of the first component.

23. The method of claim 22, further comprising:
if the actual weight of the first component is within a predefined tolerance of the desired weight associated with the first component, providing a visual display that includes a representation of a second component from the list of components and a desired weight associated with the second component.

24. The method of claim 22, wherein accepting the first component comprises printing a verification label associated with the first component.

25. The method of claim 22, further comprising:
providing the user with a display that represents a relationship between the actual component weight and the desired component weight.

26. The method of claim 25, wherein the display indicates whether the actual component weight is less than, equal to, or greater than the desired component weight.

27. The method of claim 22, further comprising:
providing the user with a display that represents the actual component weight.

28. The method of claim 22, wherein receiving the shop order identifier comprises receiving a shop order identifier that is derived from a bar code associated with the shop order.

29. The method of claim 22, wherein receiving the lot identifier associated with the first component comprises receiving a lot identifier that is derived from a bar code associated with the first component.

30. The method of claim 22, wherein updating the inventory data store comprises updating an entry in the inventory data store that is associated with the lot identifier to reflect that an amount of the first component corresponding to the actual weight of the first component is in a weight state.

31. The method of claim 22, wherein updating the inventory data store comprises updating an entry in the inventory data store that is associated with the lot identifier to reflect that an available amount of the first component is reduced by an amount of the first component corresponding to the actual weight of the first component.

32. The method of claim 22, wherein receiving the representation of the actual weight associated with the first component comprises receiving a weight signal from a scale on which a quantity of the first component has been placed.

33. The method of claim 32, wherein the predefined tolerance is based on the precision of the scale.

34. A method for charging components of a product:
receiving a shop order identifier associated with the product;
retrieving from a data store, shop order data associated with the shop order identifier, the shop order data including a list of components that are required to make the product;
receiving a representation of an actual weight of a weighed-up component from the list of components;
verifying that the actual weight of the weighed-up component is within a predefined tolerance of an expected weight associated with the weighed-up component; and
if the actual weight does not correspond to the expected weight, disapproving of an attempt by an operator to charge the weigh-up component.

35. The method of claim 34, wherein receiving the representation of the actual weight of the weighed-up component comprises receiving a weight signal from a scale on which the weighed-up component has been placed.

36. The method of claim 34, further comprising:
receiving verification data associated with the weighed-up component, the verification data including the expected weight of the weighed-up component.

37. The method of claim 36, wherein receiving the verification data comprises receiving verification data scanned from a verification label associated with the weighed-up component.

38. A method for charging components of a product, the method comprising:
receiving a shop order identifier associated with the product;
retrieving from a data store, shop order data associated with the shop order identifier, the shop order data including a list of components that are required to make the product;
receiving a lot identifier that corresponds to a weighed-up component from the list of components;
retrieving from the data store, a current lot status of a lot corresponding to the lot identifier to determine whether the weighed-up component should be used to produce the product; and
if the weighed-up component should not be used to produce the product, providing a lot status alert.

39. The method of claim 38, further comprising:
disapproving an attempt by an operator to charge the weighed-up component.

40. A method for charging components of a product, the method comprising:
receiving a representation that an actual weight of a weighed-up component has been combined with another component used to form a product;
updating a database entry corresponding to the weighed-up component to reflect a reduction in the available amount of the component by an amount that was used to form the product; and
updating a database entry corresponding to the product to reflect an increase in the available amount of the product.

41. The method of claim 40, wherein the product is an intermediate blend.

42. The method of claim 40, wherein the product is an end-product.

43. A method for charging components of a product, the method comprising:
defining a charging sequence for the components such that each component has an associated charging sequence number, the charging sequence providing an order in which the components are to be charged;
receiving a component identifier associated with a selected component selected from the list of components;
determining, from the charging sequence number associated with the selected component, whether the selected component should be charged; and
if the selected component should not be charged, providing a charging sequence alert.

44. The method of claim 43, further comprising:
disapproving an attempt by an operator to charge the selected component.

45. The method of claim 43, wherein determining whether the selected component should be charged comprises determining whether all components in the list having a sequence number that precedes the sequence number of the selected product have previously been charged.

46. The method of claim 45, wherein providing the charging sequence alert comprises providing an alert to an operator that indicates that the operator is attempting to charge the selected component out of sequence.
